(19) United States
(12) Patent Application Publication
(10) Pub. No.: US 2007/0191548 A1
(43) Pub. Date: Aug. 16, 2007

(54) Polymers comprising diallylamines

(76) Inventors: Lysander Chrisstoffels, Limburgerhof (DE); Stefan Becker, Mannheim (DE); Ludwig Volkel, Limburgerhof (DE)

Correspondence Address: CONNOLLY BOVE LODGE & HUTZ, LLP, P O BOX 2207, WILMINGTON, DE, 19899, US

(21) Appl. No.: 10/594,959

(22) PCT Filed: Mar. 26, 2005
(86) PCT No.: PCT/EP05/03215

§ 371 Date: Sep. 29, 2006

(30) Foreign Application Priority Data
Mar. 31, 2004 (DE) 102004016650.1

(51) Int. Cl. C08F 297/02

(52) U.S. Cl. 525/242

(57) ABSTRACT

The present invention relates to polymers which comprise, as monomeric building blocks, (poly)alkylene oxide-substituted diallylamines, ethylenically unsaturated monomers B, and, if appropriate, one or more further ethylenically unsaturated monomers and, if appropriate, crosslinkers, and to the use thereof as additives in cosmetic preparations.

The present invention relates to polymers comprising, as monomeric building blocks (poly)alkylene oxide-substituted diallylamines, ethylenically unsaturated monomers B, and, if appropriate, one or more further ethylenically unsaturated monomers, if appropriate crosslinkers and to the use thereof as additives in cosmetic preparations.

U.S. Pat. No. 3,585,148 describes copolymers of ethoxylated quaternary diallylamines and acrylamide and the use thereof as demulsifiers for oil which is dispersed in nonoily continuous phases.

The use of polyethoxylated diallylamines in detergents is claimed in EP 111 965 and EP 112 592. Likewise disclosed is the synthesis of the ethoxylated diallylamines from diallylamine, and the preparation of the homopolymers.

U.S. Pat. No. 5,478,883 describes the use of reaction products of diallylamine and ethylene oxide and propylene oxide as water-soluble, nonionic surface-active substances in emulsion polymerization.

For hair cosmetics, film-forming polymers are used, for example, as conditioners in order to improve the dry and wet combability, feel to the touch, shine and appearance, and to give the hair antistatic properties.

Standard commercial cationic conditioner polymers are, for example, cationic hydroxyethylcellulose, cationic polymers based on N-vinylpyrrolidone, e.g. copolymers of N-vinylpyrrolidone and quaternary N-vinylimidazole or copolymers of acrylamide and diallyldimethylammonium chloride.

Polymers which contain diallylamine derivatives as monomeric building blocks are, for example, homopolymers and copolymers of diallyldimethylammonium chloride (DADMAC).

The object forming the basis of the present invention was to provide cationic polymers which can be prepared in a cost-effective manner for use in cosmetic preparations, in particular as conditioner polymers. Upon use, in particular for hair care, these polymers should form films with good mechanical properties and give the hair good wet and dry combability, detanglability, strength and good sensorily perceptible properties such as feel, volume and handlability. In addition, the polymers should be easy to wash out, be compatible with other formulation constituents and consequently be able to be made available as clear aqueous preparations.

It has now been found that polymers comprising, as monomeric building blocks,
a) at least one diallylamine of the general formula I (monomer A) in neutral or quaternized form 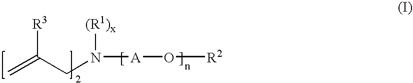
where
   A-O is C₁-C₁₂-alkylene oxide, styrene oxide or any mixtures thereof,
   n is an integer from 2 to 200,
   x is 0 or 1,
   R¹ is hydrogen, C₁- to C₂₀-alkyl, C₂- to C₂₀-alkenyl, C₅- to C₁₀-cycloalkyl or an optionally substituted benzyl radical,
   R² is hydrogen, C₁- to C₃₀-alkyl, C₅- to C₈-cycloalkyl, C₆- to C₂₀-aryl, C₁- to C₃₀-alkanoyl, C₇- to C₂₁-aroyl, sulfuric(half-)esters, phosphoric esters, amino or ammonium,
   R³ may be identical or different and is hydrogen, C₁- to C₂₀-alkyl, C₂- to C₂₀-alkenyl, C₅- to C₁₀-cycoalkyl or aryl,
b) at least one ethylenically unsaturated monomer (monomer B) chosen from the group consisting of
   i. N-vinyllactams,
   ii. N-vinylamides,
   iii. N-vinylimidazoles,
   iv. N,N-diallylamines different from monomer A, and any mixtures of these monomers or salts thereof,
c) if appropriate one or more ethylenically unsaturated monomers C,
d) if appropriate at least one crosslinker,
have advantageous properties as additives in cosmetic preparations.

C₁-C₁₂-Alkylene oxides are understood as meaning, for example, ethylene oxide, propylene oxide, 1-butylene oxide, isomers of butylene oxide, higher alkylene oxides, such as dodecene oxide, styrene oxide, and any mixtures thereof. Preferably, alkylene oxide is ethylene oxide or mixtures of ethylene oxide and propylene oxide.

In the case of mixtures, the various structural units may be arranged in different sequences such as, for example, blockwise, alternating or randomly.

n is an integer from 2 to 200, preferably from 5 to 150, particularly preferably from 10 to 100.

A C₁-C₂₀- or C₁-C₃₀-alkyl radical is understood as meaning linear or branched saturated hydrocarbon chains with up to 20 or 30, preferably with 1 to 10, carbon atoms, e.g. methyl, ethyl, n-propyl, i-propyl, n-butyl, t-butyl, n-pentyl, neopentyl, n-hexyl, 2-ethylhexyl, n-octyl, 1-decyl, 1-dodecyl etc., preferably methyl, ethyl, n-propyl or i-propyl.

A C₅-C₈-cycloalkyl radical is understood as meaning a cycloaliphatic radical having 5 to 8 carbon atoms, for example cyclopentyl, cyclohexyl, cycloheptyl or cyclooctyl, which may be optionally substituted by 1, 2, 3 or 4 C₁-C₄-alkyl groups as specified above.

C₆-C₂₀-Aryl is aryl groups which may be bonded via an alkylene unit and which may have 6 to 20 carbon atoms, e.g. benzyl, phenyl or ethylphenyl.

C₁-C₃₀-Alkanoyl is alkyl radicals which are bonded via a carbonyl group. In particular, mention may be made of formyl, acetyl, propionyl and n-butyryl.

C₇-C₂₁-Aroyl corresponds to C₇-C₂₁-arylcarbonyl and is aryl radicals which are bonded via a carbonyl group. In particular, mention may be made of benzoyl and naphthoyl.

R¹ is preferably hydrogen, C₁- to C₆-alkyl, such as methyl, ethyl, n-propyl, n-butyl or benzyl, particularly preferably hydrogen or methyl.

R² is preferably hydrogen, C₁- to C₆-alkyl, such as methyl, ethyl, n-propyl, n-butyl or phenyl, particularly preferably hydrogen or methyl.

R² is also NR′R″ (amino) or NR′R″R′″⁺ (ammonium), where R′, R″, R′″ may in each case independently of one another be identical or different and be hydrogen, a straight-chain or branched C₁-C₂₀-alkyl radical or a straight-chain or branched C₁-C₂₀-hydroxyalkyl radical, preferably hydrogen, methyl, ethyl or 2-hydroxyethyl.

R³ are substituents of the two N-allyl radicals and may be identical or different and are hydrogen, C₁- to C₂₀-alkyl, C₂- to C₂₀-alkenyl, C₅- to C₁₀-cycloalkyl or aryl. In a preferred embodiment, R³ is hydrogen.

The monomers A used are preferably alkoxylated diallylamines with 2 to 100 mol of alkylene oxide which preferably carry hydrogen or methyl as further radical R¹.

Preferred alkylene oxides here are ethylene oxide or propylene oxide, which may be present within monomer A on their own, in random, alternating or block-like sequence. A particularly preferred alkylene oxide is ethylene oxide.

In particular, the monomer A of the general formula I is present in quaternized form in the polymers according to the invention, where x is 1 and R¹ is methyl.

The N-vinyllactams i. optionally have one or more substituents, e.g. C₁-C₆-alkyl substituents.

Preferred N-vinyllactams are N-vinylpyrrolidone, N-vinylpiperidone, N-vinylcaprolactam, N-vinyl-5-methyl-2-pyrrolidone, N-vinyl-5-ethyl-2-pyrrolidone, N-vinyl-6-methyl-2-piperidone, N-vinyl-6-ethyl-2-piperidone, N-vinyl-7-methyl-2-caprolactam, N-vinyl-7-ethyl-2-caprolactam.

Preferred N-vinylamide compounds ii. are those with 1 to 4 carbon atoms in the carboxylic acid unit and hydrogen or a C₁- to C₄-alkyl, in particular methyl or ethyl group, on the nitrogen atom.

Examples which may be mentioned are N-vinylformamide, N-vinyl-N-methylformamide, N-vinylacetamide, N-vinyl-N-methylacetamide, N-vinyl-N-ethylacetamide, N-vinylpropionamide, N-vinyl-N-methylpropionamide and N-vinylbutyramide.

Preferred N-vinylimidazoles iii are N-vinylimidazoles of the general formula II 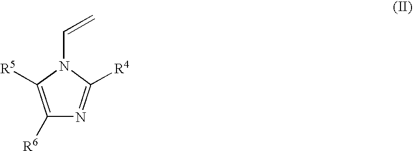
where R⁴ to R⁶, independently of one another, are hydrogen, C₁-C₄-alkyl, such as, for example, methyl or ethyl, or is phenyl. The N-vinylimidazoles may also be present in quaternized form as salts.

Preferred N,N-diallylamines iv. are N,N-diallylamines of the general formula III 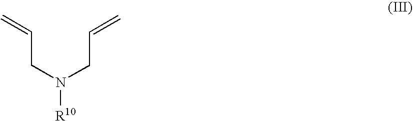
where R¹⁰ is hydrogen or C₁-C₂₄ alkyl. The diallylamines can also be present in the form of their salts. Particular preference is given to diallyldimethylammonium chloride (DADMAC).

Preferred salts of N-vinylimidazoles iii and N,N-diallylamines iv are chlorides and sulfates.

The invention provides in particular those polymers which comprise, as monomer B, N-vinylcaprolactam or N-vinylpyrrolidone or mixtures thereof.

The molar ratio of the monomers A to B is generally 20:1 to 1:50, preferably 10:1 to 1:50, in particular 1:1 to 1:30.

Besides the monomers A and B, the polymer may optionally also comprise monomers C. Suitable monomers C are in principle all ethylenically unsaturated compounds which are different from A and B.

Suitable monomers C are preferably chosen from esters of α,β-ethylenically unsaturated mono- and dicarboxylic acids with C₁-C₃₀-alkanols and C₁-C₃₀-alkanediols, amides of α,β-ethylenically unsaturated mono- and dicarboxylic acids with C₂-C₃₀-aminoalcohols which have a primary or secondary amino group, primary amides of α,β-ethylenically unsaturated monocarboxylic acids and N-alkyl and N,N-dialkyl derivatives thereof, esters of vinyl alcohol and allyl alcohol with C₁-C₃₀-monocarboxylic acids, vinyl ethers, vinylaromatics, vinyl halides, vinylidene halides, C₁-C₈-monoolefins, nonaromatic hydrocarbons with at least two conjugated double bonds and mixtures thereof.

Suitable monomers C are methyl(meth)acrylate, methyl ethacrylate, ethyl(meth)acrylate, ethyl ethacrylate, tert-butyl(meth)acrylate, tert-butyl ethacrylate, n-octyl(meth)acrylate, 1,1,3,3-tetramethylbutyl(meth)acrylate, ethylhexyl(meth)acrylate, n-nonyl(meth)acrylate, n-decyl(meth)acrylate, n-undecyl(meth)acrylate, tridecyl(meth)acrylate, myristyl(meth)acrylate, pentadecyl(meth)acrylate, palmityl(meth)acrylate, heptadecyl(meth)acrylate, nonadecyl(meth)acrylate, arrachinyl(meth)acrylate, behenyl(meth)acrylate, lignocerenyl(meth)acrylate, cerotinyl(meth)acrylate, melissinyl(meth)acrylate, palmitoleinyl(meth)acrylate, oleyl(meth)acrylate, linolyl(meth)acrylate, linolenyl(meth)acrylate, stearyl(meth)acrylate, lauryl(meth)acrylate and mixtures thereof.

Monomers C which can be used are, for example, alkyl esters or hydroxyalkyl esters of acrylic acid, methacrylic acid or maleic acid or esters of C₁-C₁₈-alcohols with acrylic acid, methacrylic acid or maleic acid alkoxylated with 2 to 50 mol of ethylene oxide, propylene oxide, butylene oxide or mixtures thereof. Suitable monomers C are 2-hydroxyethyl acrylate, 2-hydroxyethyl methacrylate, 2-hydroxyethyl ethacrylate, 2-hydroxypropyl acrylate, 2-hydroxypropyl methacrylate, 3-hydroxypropyl acrylate, 3-hydroxypropyl methacrylate, 3-hydroxybutyl acrylate, 3-hydroxybutyl methacrylate, 4-hydroxybutyl acrylate, 4-hydroxybutyl methacrylate, 6-hydroxyhexyl acrylate, 6-hydroxyhexyl methacrylate, 3-hydroxy-2-ethylhexyl acrylate, 3-hydroxy-2-ethylhexyl methacrylate etc.

(Meth)acrylamides are amides of acrylic acid or of methacrylic acid. Suitable monomers C are also acrylamide, methacrylamide, N-methyl(meth)acrylamide, N-ethyl(meth)acrylamide, N-propyl(meth)acrylamide, N-(n-butyl)(meth)acrylamide, N-(tert-butyl)(meth)acrylamide, N-(n-octyl)(meth)acrylamide, N-(1,1,3,3-tetramethylbutyl)(meth)acrylamide, N-ethylhexyl(meth)acrylamide, N-(n-nonyl)(meth)acrylamide, N-(n-decyl)(meth)acrylamide, N-(n-undecyl)(meth)acrylamide, N-tridecyl(meth)acrylamide, N-myristyl(meth)acrylamide, N-pentadecyl(meth)acrylamide, N-palmityl-(meth)acrylamide, N-heptadecyl(meth)acrylamide, N-nonadecyl(meth)acrylamide, N-arrachinyl(meth)acrylamide, N-behenyl(meth)acrylamide, N-lignocerenyl-(meth)acrylamide, N-cerotinyl(meth)acrylamide, N-melissinyl(meth)acrylamide, N-palmitoleinyl(meth)acrylamide, N-oleyl(meth)acrylamide, N-linolyl(meth)acrylamide, N-linolenyl(meth)acrylamide, N-stearyl(meth)acrylamide, N-lauryl(meth)acrylamide, N,N-dimethyl(meth)acrylamide, N,N-diethyl(meth)acrylamide, morpholinyl-(meth)acrylamide.

In a preferred embodiment, monomer C is methacrylamide.

Further suitable monomers C are vinyl acetate, vinyl propionate, vinyl butyrate and mixtures thereof.

Suitable monomers C are also ethylene, propylene, 1-butene, 2-butene, isoprene, isobutylene, butadiene, cyclohexadiene, styrene, tert-butylstyrene, α-methylstyrene, vinyltoluene, acrylonitrile, methacrylonitrile, vinyl chloride, vinylidene chloride, vinyl fluoride, vinylidene fluoride and any mixtures thereof.

The monomers C may be used individually or in the form of any mixtures.

The polymers generally comprise 1-95 mol % of monomer A, 5-99 mol % of monomer B and 0-50 mol % of monomer C.

The alkylene oxides may be prepared, for example, by alkoxylation of diallylamine in a plurality of steps. In a first step, diallylamine is reacted with at least one equivalent of alkylene oxide in the presence or absence of a solvent. The precursor obtained in this way is reacted further with alkylene oxide in the presence of a catalyst, it being possible to use all of the catalysts known from the prior art for the polymerization of alkylene oxides—suitable catalysts being all those known from the prior art for the polymerization of alkylene oxides and compatible with amines. A review of a number of catalysts is given, for example, in F. E. Bailey, Jr, J. V. Koleske, Alkylene Oxides and their Polymers, NY and Basel 1991, p. 35 ff. Particular preference is given to using basic catalysts such as NaOH, KOH, CsOH, K tert-butoxide, NaOMe or mixtures of the bases with crown ethers.

The addition product of alkylene oxides and diallylamine can be functionalized further. For example, quaternization can be carried out with alkylating agents, the OH groups can be converted into sulfates, sulfonates, phosphates or phosphonates. The amine nitrogen can be converted into a charged cationic group by protonation, e.g. with carboxylic acids, such as lactic acid, or mineral acids, such as phosphoric acid, sulfuric acid and hydrochloric acid, or by quaternization, e.g. with alkylating agents, such as C₁-C₄-alkyl halides or sulfates.

Examples of such alkylating agents are ethyl chloride, ethyl bromide, methyl chloride, methyl bromide, dimethyl sulfate and diethyl sulfate. A protonation or quaternization can generally take place either before or after the polymerization. This results then in cationic, anionic, amphoteric or betainic structures.

Preparation of the Polymers

The invention also provides processes for the preparation of the polymers according to the invention, wherein the monomers A and B and optionally C and optionally a crosslinker are free-radically polymerized.

The polymers can be carried out in accordance with customary polymerization processes as bulk polymerization, solution polymerization and, in cases of lower solubility of the monomers, also as emulsion, dispersion or suspension polymerization. It is likewise possible, if the solubility of the polymer in the reaction mixture is sufficiently low, to carry out the polymerization as precipitation polymerization.

In the case of the polymerization processes specified, preference is given to working under the exclusion of oxygen, in particular in a stream of inert gas, particularly preferably in a stream of nitrogen. For all polymerization methods, the customary apparatuses are used, e.g. stirred tanks, stirred-tank cascades, autoclaves, tubular reactors, and kneaders. Preference is given to the methods of solution and emulsion polymerization. If the preparation of the polymers according to the invention takes place by free-radical, aqueous emulsion polymerization, it is advisable to add surfactants or protective colloids to the reaction medium. A list of suitable emulsifiers and protective colloids is given, for example, in Houben Weyl, Methoden der organischen Chemie [Methods of organic chemistry], volume XIV/1 Makromolekulare Stoffe [Macromolecular substances], Georg Thieme Verlag, Stuttgart 1961, p. 411 ff.

The polymerization can be carried out in solvents or diluents, such as, for example, toluene, o-xylene, p-xylene, cumene, chlorobenzene, ethylbenzene, technical-grade mixtures of alkylaromatics, cyclohexane, technical-grade aliphatic mixtures, acetone, cyclohexanone, tetrahydrofuran, dioxane, glycols and glycol derivatives, polyalkylene glycols and derivatives thereof, diethyl ethers, tert-butyl methyl ether, methyl acetate, isopropanol, ethanol, water or mixtures, such as, for example, isopropanol/water mixtures. The solvent or diluent used is preferably water, optionally with contents up to 60% by weight of alcohols or glycols. Particular preference is given to using water.

The polymerization can be carried out at temperatures of from 20° to 300°, preferably from 400 to 150° C.

Initiators

The polymerization is preferably carried out in the presence of compounds which form free radicals. Up to 30% by weight of these compounds are generally used, preferably 0.05 to 15% by weight, particularly preferably 0.2 to 8% by weight, based on the monomers used in the polymerization. In the case of multicomponent initiator systems (e.g. redox initiator systems), the weights given above refer to the sum of the components.

Suitable polymerization initiators are, for example, peroxides, hydroperoxides, peroxodisulfates, percarbonates, peroxide esters, hydrogen peroxide and azo compounds. Examples of initiators which may be water-soluble or else water-insoluble are hydrogen peroxide, dibenzoyl peroxide, dicyclohexyl peroxidicarbonate, dilauroyl peroxide, methylethyl ketone peroxide, di-tert-butyl hydroperoxide, acetylacetone peroxide, tert-butyl hydroperoxide, cumene hydroperoxide, tert-butyl perneodecanoate, tert-amyl perpivalate, tert-butyl perpivalate, tert-butyl perbenzoate, lithium peroxodisulfate, sodium peroxodisulfate, potassium peroxodisulfate and ammonium peroxodisulfate and azodiisobutyronitrile, 2,2′-azobis(2-amidinopropane)-hydrochloride.

The initiators can be used on their own or in a mixture with one another, e.g. mixtures of hydrogen peroxide and sodium peroxodisulfate. For polymerization in aqueous medium, preference is given to using water-soluble initiators.

The known redox initiator systems can also be used as polymerization initiators. Such redox initiator systems comprise at least one peroxide-containing compound in combination with a redox coinitiator e.g. sulfur compounds with a reducing effect, for example bisulfites, sulfites, thiosulfates, dithionites and tetrathionates of alkali metals and ammonium compounds. For example, it is possible to use combinations of peroxodisulfates with alkali metal or ammonium hydrogensulfites, e.g. ammonium peroxodisulfate and ammonium disulfite. The amount of peroxide-containing compound relative to the redox coinitiator can be 30:1 to 0.05:1.

In combination with the initiators or the redox initiator systems it is additionally possible to use transition metal catalysts, e.g. salts of iron, cobalt, nickel, copper, vanadium and manganese. Suitable salts are, for example, iron(II)sulfate, cobalt(II)chloride, nickel(II)sulfate, or copper(I)chloride. Based on the monomers, the reducing transition metal salt is used in a concentration of from 0.1 ppm to 1000 ppm. For example, it is possible to use combinations of hydrogen peroxide with iron(II) salts, such as, for example, 0.5 to 30% hydrogen peroxide and 0.1 to 500 ppm of Mohr's salt.

In the case of polymerization in organic solvents too, it is possible to co-use redox coinitiators and/or transition metal catalysts in combination with the abovementioned initiators, e.g. benzoin, dimethylaniline, ascorbic acid, and organically soluble complexes of heavy metals, such as copper, cobalt, iron, manganese, nickel and chromium. The customarily used amounts of redox coinitiators or transition metal catalysts are about 0.1 to 1000 ppm, based on the amounts of monomers used.

Molecular Weight

The molecular weight of the polymers (number-average molecular weight Mₙ or mass-average molecular weight M_{w}) can be influenced through the choice of reaction parameters such as, for example, solvents, regulators, crosslinkers, amount of initiator, reaction time and/or temperature.

Depending on the choice of polymerization conditions it is possible to establish weight-average molecular weights (M_{w}) of, for example, 1000 to 2 000 000, preferably 5000-50 000. M_{w} is determined by gel permeation chromatography (GPC).

The K values of the aqueous sodium salt solutions of the copolmers were determined in accordance with H. Fikentscher, Cellulose-Chemie, volume 13, 58-64 and 71-74 (1932) in aqueous solution at a pH of 7, a temperature of 25° C. and a polymer concentration of the sodium salt of the copolymer of 1% by weight.

Regulators

In order to control the average molecular weight of the polymers, it is often expedient to carry out the copolymerization in the presence of regulators. For this purpose it is possible to use customary regulators, such as, for example, organic compounds containing SH groups, such as 2-mercaptoethanol, 2-mercaptopropanol, 3-mercaptopropionic acid, cysteine, N-acetylcysteine, but also sodium hypophosphite or sodium hydrogensulfite. The regulators used are preferably alkanethiols. It is also possible to use mixtures of two or more regulators.

Alkanethiols which may be used are linear and branched alkanethiols with a carbon chain length of from C₁₀ to C₂₂. Preference is given to linear alkanethiols, in particular alkanethiols with a chain length of from C₁₂ to C₂₂, very particularly from C₁₂ to C₁₈. Preferred alkanethiols which may be mentioned are n-decanethiol, n-dodecanethiol, tert-dodecanethiol, n-tetradecanethiol, n-pentadecanethiol, n-hexadecanethiol, n-heptadecanethiol, n-octadecanethiol, n-nonadecanethiol, n-eicosanethiol, n-docosanethiol. Particular preference is given to linear, even-numbered alkanethiols.

The alkanethiols can likewise be used in mixtures. The alkanethiols are usually added to the polymerization together with the monomers. The polymerization regulators are generally used in amounts of from 0.1 to 10% by weight, based on the monomers.

The average molecular weight can also be influenced through the choice of suitable solvent. For example, the polymerization in the presence of diluents with benzylic H atoms leads to a reduction in the average molecular weight as a result of chain transfer.

Crosslinkers

In order to increase the molecular weight of the polymers, it may be expedient to carry out the copolymerization in the presence of crosslinkers.

Suitable crosslinkers are, for example, acrylic esters, methacrylic esters, allyl ethers or vinyl ethers of at least dihydric alcohols. The OH groups of the parent alcohols may here be completely or partially etherified or esterified; however, the crosslinkers contain at least two ethylenically unsaturated groups.

Examples of the parent alcohols are divalent alcohols such as 1,2-ethanediol, 1,2-propanediol, 1,3-propanediol, 1,2-butanediol, 1,3-butanediol, 2,3-butanediol, 1,4-butanediol, but-2-en-1,4-diol, 1,2-pentanediol, 1,5-pentanediol, 1,2-hexanediol, 1,6-hexanediol, 1,10-decanediol, 1,2-dodecanediol, 1,12-dodecanediol, neopentyl glycol, 3-methylpentane-1,5-diol, 2,5-dimethyl-1,3-hexanediol, 2,2,4-trimethyl-1,3-pentanediol, 1,2-cyclohexanediol, 1,4-cyclohexanediol, 1,4-bis(hydroxymethyl)-cyclohexane, neopentyl glycol monohydroxypivalate, 2,2-bis(4-hydroxyphenyl)propane, 2,2-bis[4-(2-hydroxypropyl)phenyl]propane, diethylene glycol, triethylene glycol, tetraethylene glycol, dipropylene glycol, tripropylene glycol, tetrapropylene glycol, 3-thiopentane-1,5-diol, and also polyethylene glycols, polypropylene glycols and polytetrahydrofurans with molecular weights of in each case 200 to 10 000. Apart from the homopolymers of ethylene oxide or propylene oxide, it is also possible to use block copolymers of ethylene oxide or propylene oxide or copolymers which contain ethylene oxide and propylene oxide groups in incorporated form. Examples of parent alcohols with more than two OH groups are trimethylolpropane, glycerol, pentaerythritol, 1,2,5-pentanetriol, 1,2,6-hexanetriol, triethoxycyanuric acid, sorbitan, sugars such as sucrose, glucose, mannose. The polyhydric alcohols can of course also be used following reaction with ethylene oxide or propylene oxide, in the form of the corresponding ethoxylates or propoxylates. The polyhydric alcohols can also firstly be converted into the corresponding glycidyl ethers by reaction with epichlorohydrin.

Further suitable crosslinkers are the vinyl esters or the esters of monohydric, unsaturated alcohols with ethylenically unsaturated C₃- to C₆-carboxylic acids, for example acrylic acid, methacrylic acid, itaconic acid, maleic acid or fumaric acid. Examples of such alcohols are allyl alcohol, 1-buten-3-ol, 5-hexen-1-ol, 1-octen-3-ol, 9-decen-1-ol, dicyclopentenyl alcohol, 10-undecen-1-ol, cinnamyl alcohol, citronellol, crotyl alcohol or cis-9-octadecen-1-ol. It is, however, also possible to esterify the monohydric, unsaturated alcohols with polybasic carboxylic acids, for example malonic acid, tartaric acid, trimellitic acid, phthalic acid, terephthalic acid, citric acid or succinic acid.

Further suitable crosslinkers are esters of unsaturated carboxylic acids with the above-described polyhydric alcohols, for example oleic acid, crotonic acid, cinnamic acid or 10-undecanoic acid.

Suitable crosslinkers are also straight-chain or branched, linear or cyclic, aliphatic or aromatic hydrocarbons which have at least two double bonds which, in the case of aliphatic hydrocarbons, must not be conjugated, e.g. divinylbenzene, divinyltoluene, 1,7-octadiene, 1,9-decadiene, 4-vinyl-1-cyclohexene, trivinylcyclohexane or polybutadienes with molecular weights of from 200 to 20 000.

Suitable crosslinkers are also the acrylamides, methacrylamides and N-allylamines of at least dihydric amines. Such amines are, for example, 1,2-diaminomethane, 1,2-diaminoethane, 1,3-diaminopropane, 1,4-diaminobutane, 1,6-diaminohexane, 1,12-dodecandiamine, piperazine, diethylenetriamine or isophoronediamine. Likewise suitable are the amides of allylamine and unsaturated carboxylic acids, such as acrylic acid, methacrylic acid, itaconic acid, maleic acid, or at least dibasic carboxylic acids, as have been described above.

Particularly suitable crosslinkers are triallylamine and triallylmonoalkylammonium salts, e.g. triallylmethylammonium chloride or methylsulfate.

Also suitable are N-vinyl compounds of urea derivatives, at least divalent amides, cyanurates or urethanes, for example of urea, ethyleneurea, propyleneurea or tartardiamide, e.g. N,N′-divinylethyleneurea or N,N′-divinylpropyleneurea.

Further suitable crosslinkers are divinyidioxane, tetraallylsilane or tetravinylsilane.

It is of course also possible to use mixtures of the abovementioned compounds. Preference is given to using those crosslinkers which are soluble in the solution or dispersion of the monomers.

Particularly preferred crosslinkers are, for example, methylenebisacrylamide, triallylamine and triallylalkylammonium salts, divinylimidazole, pentaerythritol triallyl ether, N,N′-divinylethyleneurea, reaction products of polyhydric alcohols with acrylic acid or methacrylic acid, methacrylic esters and acrylic esters of polyalkylene oxides or polyhydric alcohols which have been reacted with ethylene oxide and/or propylene oxide and/or epichlorohydrin.

Very particularly preferred crosslinkers are pentaerythritol triallyl ether, methylenebisacrylamide, N,N′-divinylethyleneurea, triallylamine and triallylmonoalkylammonium salts, and acrylic esters of glycol, butanediol, trimethylolpropane or glycerol or acrylic esters of glycol, butanediol, trimethylolpropane or glycerol which have been reacted with ethylene oxide and/or epichlorohydrin.

The crosslinkers are usually used in an amount of 0.01-5% by weight, based on the total amount of the monomers A, B and C.

Work-Up

If the polymer is obtained by the process of solution polymerization in water, then it is usually not necessary to separate off the solvent. If it is nevertheless desired to isolate the polymer, a spray-drying can, for example, be carried out.

If the polymer is prepared by the method of solution, precipitation or suspension polymerization in a steam-volatile solvent or solvent mixture, then the solvent can be separated off by introducing steam in order thus to arrive at an aqueous solution or dispersion. The polymer can also be separated off from the organic diluent by a drying process.

In a preferred embodiment, the polymers according to the invention are soluble or dispersible in water.

For the purposes of the present invention, water-soluble monomers and polymers are understood as meaning monomers and polymers which dissolve in 1 liter of water in an amount of at least 1 g.

Water-dispersible monomers and polymers are understood as meaning monomers and polymers which disintegrate into dispersible particles under the application of shear forces, for example by stirring. Hydrophilic monomers are preferably water-soluble or at least water-dispersible. The polymers according to the invention are generally dispersible or soluble in aqueous media.

Preferably, the polymers are in the form of an aqueous solution or dispersion with solids contents of preferably 10 to 80% by weight.

The K values of the polymers are preferably in the range from 20-120.

The polymers may be provided for the cosmetic preparations in dissolved or solid form which is obtainable by drying, for example by spray-drying of polymer solutions or dispersions, as are produced during the polymerization. The polymer is preferably used in liquid, i.e. dissolved, emulsified or suspended, form, for example in the form of the, in particular, aqueous polymerization solution for producing the cosmetic preparations.

Use in Cosmetic Preparations

The above-described polymers are exceptionally suitable for preparing cosmetic and dermatological compositions. The invention thus further provides the use of the polymers according to the invention in cosmetic or dermatological compositions.

The invention further provides the use of polymers comprising, as monomer building blocks,

a) at least one diallylamine of the general formula I (monomer A) as defined above,

b) one or more ethylenically unsaturated monomers B and/or C as defined above,

c) and if appropriate at least one crosslinker

in cosmetic or dermatological preparations.

The polymers according to the invention are used, for example, as polymeric film formers in preparations for body care, which involves the application of cosmetic preparations to keratinous surfaces such as skin, hair, nails, and also mouthcare preparations. They can be used and formulated universally in a very wide variety of cosmetic preparations and are compatible with customary components. The dispersions according to the invention are characterized in particular by excellent conditioner properties.

The invention thus further provides cosmetic or dermatological compositions comprising
at least one polymer according to the invention and
at least one cosmetically or dermatologically acceptable carrier.

In these cosmetic compositions, moreover, instead of the monomers B, the monomers C may be present as building blocks within the polymer.

The compositions according to the invention have a cosmetically or dermatologically acceptable carrier which is preferably chosen from
1) water,
2) water-miscible organic solvents, preferably C₁-C₄-alkanols,
3) oils, fats, waxes,
4) esters of C₆-C₃₀-monocarboxylic acids with mono-, di- or trihydric alcohols which are different from 3),
5) saturated acyclic and cyclic hydrocarbons,
6) fatty acids,
7) fatty alcohols
8) silicone oils
   and mixtures thereof.

The compositions according to the invention have, for example, an oil or a fat component which is chosen, for example, from:
hydrocarbons of low polarity, such as mineral oils,
linear saturated hydrocarbons, preferably with more than 8 carbon atoms, such as tetradecane, hexadecane, octadecane etc.,
cyclic hydrocarbons, such as decahydronaphthalene,
branched hydrocarbons,
animal and vegetable oils,
waxes and wax esters,
vaseline,
esters, preferably esters of fatty acids, such as, for example, the esters of C₁-C₂₄-monoalcohols with C₁-C22-monocarboxylic acids, such as isopropyl isostearate, n-propyl myristate, isopropyl myristate, n-propyl palmitate, isopropyl palmitate, hexacosanyl palmitate, octacosanyl palmitate, triacontanyl palmitate, dotriacontanyl palmitate, tetratriacontanyl palmitate, hexacosanyl stearate, octacosanyl stearate, triacontanyl stearate, dotriacontanyl stearate, tetratriacontanyl stearate,
salicylates, such as C₁-C₁₀-salicylates, e.g. octyl salicylate; benzoate esters, such as C₁₀-C₁₅-alkyl benzoates, benzyl benzoate,
other cosmetic esters, such as fatty acid triglycerides, propylene glycol monolaurate, polyethylene glycol monolaurate, C₁₀-C₁₅-alkyllactates, etc. and mixtures thereof.

Further preferred oil and fat components are chosen from paraffin and paraffin oils, natural fats and oils, such as castor oil, soybean oil, peanut oil, olive oil, sunflower oil, sesame oil, avocado oil, cocoa butter, almond oil, peach kernel oil, ricinus oil, cod-liver oil, lard, spermaceti, spermaceti oil, sperm oil, wheatgerm oil, macadamia nut oil, evening primrose oil, jojoba oil, fatty alcohols, such as lauryl alcohol, myristyl alcohol, cetyl alcohol, stearyl alcohol, oleyl alcohol, cetyl alcohol; fatty acids, such as myristic acid, stearic acid, palmitic acid, oleic acid, linoleic acid, linolenic acid and saturated, unsaturated and substituted fatty acids which are different therefrom; waxes, such as beeswax, carnauba wax, candililla wax, spermaceti and mixtures of the abovementioned oil or fat components.

Suitable silicone oils are, for example, linear polydimethylsiloxanes, poly(methylphenylsiloxanes), cyclic siloxanes, and amino-, fatty acid-, alcohol-, polyether-, epoxy-, fluorine-, glycoside- and/or alkyl-modified silicone compounds which may either be liquid or in resin form at room temperature, and mixtures thereof. The number-average molecular weight of the polydimethylsiloxanes and poly(methylphenylsiloxanes) is preferably in a range from about 1000 to 150 000 g/mol. Preferred cyclic siloxanes have 4- to 8-membered rings. Suitable cyclic siloxanes are commercially available, for example, under the name cyclomethicone.

Suitable cosmetically and dermatologically compatible oil and fat components are described in Karl-Heinz Schrader, Grundlagen und Rezepturen der Kosmetika [Fundamentals and formulations of cosmetics], 2nd edition, Verlag Hüthig, Heidelberg, pp. 319-355, which is herein incorporated by reference.

Particularly suitable hydrophilic carriers are chosen from water, mono-, di- or polyhydric alcohols having preferably 1 to 8 carbon atoms, such as ethanol, n-propanol, isopropanol, propylene glycol, glycerol, sorbitol, etc.

The cosmetic compositions according to the invention may be skin cosmetic, hair cosmetic, dermatological, hygiene or pharmaceutical compositions. Due to their film-forming properties, the polymers described above are suitable in particular as additives for hair and skin cosmetics, very particularly preferably as additives for hair cosmetic preparations.

The compositions according to the invention are preferably in the form of a gel, foam, spray, ointment, cream, emulsion, suspension, lotion, milk or paste. If desired, liposomes or microspheres may also be used.

The cosmetically or dermatologically active compositions according to the invention may additionally comprise cosmetically and/or dermatologically active ingredients and also auxiliaries.

Preferably, the cosmetic compositions according to the invention comprise at least one polymer according to the invention, at least one carrier as defined above and at least one constituent different from the polymer which is chosen from cosmetically active ingredients, emulsifiers, surfactants, preservatives, perfume oils, thickeners, hair polymers, hair and skin conditioners, graft polymers, water-soluble or dispersible silicone-containing polymers, photoprotective agents, bleaches, gel formers, care agents, colorants, tints, tanning agents, dyes, pigments, bodying agents, humectants, refatting agents, collagen, protein hydrolysates, lipids, antioxidants, antifoams, antistats, emollients and softeners.

If appropriate, the cosmetic preparations can comprise perfume oils. Perfume oils which may be mentioned are, for example, mixtures of natural and synthetic odorants.

Natural odorants are extracts from flowers (lily, lavender, rose, jasmine, neroli, ylang-ylang), stems and leaves (geranium, patchouli, petitgrain), fruits (aniseed, coriander, cumin, juniper), fruit peels (bergamot, lemon, orange), roots (mace, angelica, celery, cardamon, costus, iris, calmus), woods (pinewood, sandalwood, guaiac wood, cedar wood, rose wood), herbs and grasses (tarragon, lemongrass, sage, thyme), needles and branches (spruce, fir, pine, dwarf-pine), resins and balsams (galbanum, elemi, benzoin, myrrh, olibanum, opoponax).

Also suitable are animal raw materials, such as, for example, cibet and castoreum. Typical synthetic odorant compounds are products of the ester, ether, aldehyde, ketone, alcohol and hydrocarbon type. Odorant compounds of the ester type are, for example, benzyl acetate, phenoxyethyl isobutyrate, 4-tert-butylcyclohexyl acetate, linalyl acetate, dimethylbenzylcarbinyl acetate, phenylethyl acetate, linalyl benzoate, benzyl formate, ethyl methylphenylglycinate, allyl cyclohexylpropionate, styrallyl propionate and benzyl salicylate. The ethers include, for example, benzyl ethyl ether, the aldehydes include, for example, the linear alkanals having 8 to 18 carbon atoms, citral, citronellal, citronellyloxyacetaldehyde, cyclamenaldehyde, hydroxycitronellal, lilial and bourgeonat, the ketones include, for example, the ionones, cc-isomethylionene and methyl cedryl ketone, the alcohols include anethol, citronellol, eugenol, isoeugenol, geraniol, linalool, phenylethyl alcohol and terioneol, and the hydrocarbons include primarily the terpenes and balsams.

Preference is, however, given to using mixtures of different odorants which together produce a pleasing scent note. Essential oils of lower volatility, which are mostly used as aroma components, are also suitable as perfume oils, e.g. sage oil, chamomile oil, oil of cloves, balm oil, mint oil, cinnamon leaf oil, lime blossom oil, juniper berry oil, vetiver oil, olibanum oil, galbanum oil, labolanum oil and lavandin oil. Preference is given to using bergamot oil, dihydromyrcenol, lilial, lyral, citronellol, phenylethyl alcohol, α-hexylcinnamaldehyde, geraniol, benzylacetone, cyclamenaldehyde, linalool, Boisambrene® Forte, ambroxan, indole, hedione, sandelice, lemon oil, mandarin oil, orange oil, allyl amyl glycolate, cyclovertal, lavandin oil, muscatel sage oil, β-damascone, geranium oil bourbon, cyclohexyl salicylate, Vertofix® Coeur, Iso-E-Super, Fixolide® NP, evernyl, iraldein gamma, phenylacetic acid, geranyl acetate, benzyl acetate, rose oxide, romillat, irotyl and floramat alone or in mixtures.

Customary thickeners are crosslinked polyacrylic acids and derivatives thereof, polysaccharides such as xanthan gum, agar agar, alginates or Tyloses, cellulose derivatives, e.g. carboxymethylcellulose or hydroxycarboxymethylcellulose, fatty alcohols, monoglycerides and fatty acids, polyvinyl alcohol and polyvinylpyrrolidone. Suitable thickeners are also the Aculyn® grades from Rohm and Haas, such as Aculyn® 22 (copolymer of acrylates and methacrylic acid ethoxylates with stearyl radical (20 EO units)) and Aculyn® 28 (copolymer of acrylates and methacrylic acid ethoxylates with behenyl radical (25 EO units)).

Suitable cosmetically and/or dermatologically active ingredients are, for example, coloring active ingredients, skin and hair pigmentation agents, tinting agents, tanning agents, bleaches, keratin-hardening substances, antimicrobial active ingredients, light filter active ingredients, repellent active ingredients, substances with a hyperemic effect, substances with a keratolytic and keratoplastic effect, antidandruff active ingredients, antiphlogistics, substances with a keratinizing effect, active ingredients with an antioxidative or free-radical scavenging effect, substances which wet the skin or retain moisture, refatting active ingredients, antierythematous or antiallergic active ingredients and mixtures thereof.

Active ingredients which tan the skin artificially and which are suitable for tanning the skin without natural or artificial irradiation with UV rays are, for example, dihydroxyacetone, alloxan and walnut shell extract.

Suitable keratin-hardening substances are usually active ingredients as are also used in antiperspirants, such as, for example, potassium aluminum sulfate, aluminum hydroxychloride, aluminum lactate, etc.

Antimicrobial active ingredients are used to destroy microorganisms or to inhibit their growth and thus serve both as preservatives and also as deodorizing substance which prevents the formation or the intensity of body odor. These include, for example, customary preservatives, such as p-hydroxybenzoic esters, imidazolidinyl urea, formaldehyde, sorbic acid, benzoic acid, salicylic acid, etc. Such deodorizing substances are, for example, zinc ricinoleate, triclosan, undecylenic alkylolamides, triethyl citrate, chlorhexidine etc.

Suitable light filter active ingredients are substances which absorb UV rays in the UV-B and/or UV-A region. Suitable UV filters are, for example, 2,4,6-triaryl-1,3,5-triazines in which the aryl groups may in each cased carry at least one substituent which is preferably chosen from hydroxy, alkoxy, specifically methoxy, alkoxycarbonyl, specifically methoxycarbonyl and ethoxycarbonyl and mixtures thereof. Also suitable are p-aminobenzoic esters, cinnamic esters, benzophenones, camphor derivatives, and pigments which stop UV rays, such as titanium dioxide, talc and zinc oxide.

Suitable repellent active ingredients are compounds which are able to drive away or keep certain animals, in particular insects, away from humans. These include, for example, 2-ethyl-1,3-hexanediol, N,N-diethyl-m-toluamide etc. Suitable substances with hyperemic activity, which stimulate the blood flow through the skin, are, for example, essential oils, such as dwarf pine, lavender, rosemary, juniper berry, roast chestnut extract, birch leaf extract, hay seed extract, ethyl acetate, camphor, menthol, peppermint oil, rosemary extract, eucalyptus oil, etc.

Suitable keratolytic and keratoplastic substances are, for example, salicylic acid, calcium thioglycolate, thioglycolic acid and its salts, sulfur, etc. Suitable antidandruff active ingredients are, for example, sulfur, sulfur polyethylene glycol sorbitan monooleate, sulfur ricinol polyethoxylate, zinc pyrithione, aluminum pyrithione, etc.

Suitable antiphlogistics, which counter skin irritations, are, for example, allantoin, bisabolol, dragosantol, chamomile extract, panthenol, etc.

The light protection filters used in cosmetic and dermatological preparations have the task of preventing the harmful effects of sunlight on human skin, or at least reducing their consequences. In addition, these light protection filters, however, also serve to protect further ingredients against decomposition or degradation by UV radiation. In hair cosmetic formulations, damage to keratin fibers by UV rays should be reduced.

To protect against UV-B radiation, numerous compounds are known which are, inter alia, derivatives of 3-benzylidenecamphor, of 4-aminobenzoic acid, of cinnamic acid, of salicylic acid, of benzophenone, and of 2-phenylbenzimidazole.

UV light protection filters which can be used are oil-soluble organic UV-A filters and/or UV-B filters and/or water-soluble organic UV-A filters and/or UV-B filters. The total amount of UV light protection filters is generally 0.1% by weight to 30% by weight, preferably 0.5 to 15% by weight, in particular 1 to 10% by weight, based on the total weight of the preparations.

The UV light protection filters are advantageously chosen such that the preparations protect the skin against the entire range of ultraviolet radiation.

Examples of UV light protection filters are:
4-aminobenzoic acid
3-(4′-trimethylammonium)benzylidenebornan-2-one methyl sulfate
3,3,5-trimethylcyclohexyl salicylate(homosalate)
2-hydroxy-4-methoxybenzophenone(oxybenzonum)
2-phenylbenzimidazole-5-sulfonic acid and its potassium, sodium and triethanolamine salts
3,3′-(1,4-phenylenedimethine)bis(7,7-dimethyl-2-oxobicyclo[2.2.1]heptane-1-methanesulfonic acid) and its salts
polyethoxyethyl 4-bis(polyethoxy)aminobenzoate
2-ethylhexyl 4-dimethylaminobenzoate
2-ethylhexyl salicylate
2-isoamyl 4-methoxycinnamate
2-ethylhexyl 4-methoxycinnamate
2-hydroxy-4-methoxybenzophenone-5-sulfonic acid(sulisobenzonum) and the sodium salt
3-(4′-sulfo)benzylidenebornan-2-one and salts
3-benzylidenebornan-2-one
1-(4′-isopropylphenyl)-3-phenylpropane-1,3-dione
4-isopropylbenzylsalicylate
2,4,6-trianilino-(o-carbo-2′-ethylhexyl-1′-oxy)-1,3,5-triazine
3-imidazol-4-ylacrylic acid and its ethyl ester
menthyl o-aminobenzoates or: 5-methyl-2-(1-methylethyl)-2-aminobenzoates
glyceryl p-aminobenzoate or 1-glyceryl 4-aminobenzoate
2,2′-dihydroxy-4-methoxybenzophenone(dioxybenzones)
2-hydroxy-4-methoxy-4-methylbenzophenone(mexenone)
triethanolamine salicylate
dimethoxyphenylglyoxalic acid or: sodium 3,4-dimethoxyphenylglyoxalate
3-(4′-sulfo)benzylidenebornan-2-one and its salts
2,2′,4,4′-tetrahydroxybenzophenone
2,2′-methylenebis[6(2H-benzotriazol-2-yl)-4-(1,1,3,3,-tetramethylbutyl)phenol]
2,2′-(1,4-phenylene)bis-1H-benzimidazole-4,6-disulfonic acid, Na salt
2,4-bis[4-(2-ethylhexyloxy)-2-hydroxy]phenyl-6-(4-methoxyphenyl)-(1,3,5)-triazine
3-(4-methylbenzylidene)camphor
polyethoxyethyl 4-bis(polyethoxy)paraaminobenzoate
2,4-dihydroxybenzophenone
2,2′-dihydroxy-4,4′-dimethoxybenzophenone-5,5′-disodium sulfonate

Suitable bodying agents are primarily fatty alcohols or hydroxy fatty alcohols having 12 to 22 and preferably 16 to 18 carbon atoms and also partial glycerides, fatty acids or hydroxy fatty acids. Preference is given to a combination of these substances with alkyl oligoglucosides and/or fatty acid N-methylglucamides of identical chain length and/or polyglycerol poly-12-hydroxystearates. Suitable thickeners are, for example, polysaccharides, in particular xanthan gum, guar gum, agar agar, alginates and tyloses, carboxymethylcellulose and hydroxyethylcellulose, and also higher molecular weight polyethylene glycol mono- and diesters of fatty acids, polyacrylates (e.g. Carbopol™ from Goodrich or Synthalen™ from Sigma), polyacrylamides, polyvinyl alcohol and polyvinylpyrrolidone, surfactants, such as, for example, ethoxylated fatty acid glycerides, esters of fatty acids with polyols such as, for example, pentaerythritol or trimethylolpropane, fatty alcohol ethoxylates with narrowed homolog distribution or alkyl oligoglucosides, and electrolytes such as sodium chloride and ammonium chloride.

Superfatting agents which may be used are substances such as, for example, lanolin and lecithin, and polyethoxylated or acylated lanolin and lecithin derivatives, polyol fatty acid esters, monoglycerides and fatty acid alkanolamides, the latter also serving as foam stabilizers.

Antioxidants are usually compounds known per se. The antioxidants are advantageously chosen from the groups of carotenoids, carotenes (e.g. α-carotene, β-carotene, lycopene) and derivatives thereof, chlorogenic acid and derivatives thereof, lipoic acid and derivatives thereof (e.g. dihydrolipoic acid), and also (metal) chelating agents, EDTA, EGTA and derivatives thereof, ubiquinone and ubiquinol and derivatives thereof, vitamin C and derivatives (e.g. ascorbyl palmitate, Mg ascorbyl phosphate, ascorbyl acetate), tocopherols and derivatives (e.g. vitamin E acetate), vitamin A and derivatives (vitamin A palmitate), butylhydroxytoluene, butylhydroxyanisole, and further antioxidants customarily used in cosmetic preparations.

The amount of the abovementioned antioxidants (a) in the finished preparations is, for example, 0.001 to 30% by weight, preferably 0.01 to 10% by weight and in particular 1 to 5% by weight.

In addition, antibacterial additives may also be used. These generally include all suitable preservatives with specific action against gram-positive bacteria, e.g. triclosan (2,4,4′-trichloro-2′-hydroxydiphenyl ether), chlorhexidine (1,1′-hexamethylenebis-[5-(4-chlorophenyl)biguanide) and TTC (3,4,4′-trichlorocarbanilide).

Quaternary ammonium compounds are in principle likewise suitable, but are preferably used for disinfecting soaps and washing lotions.

Numerous odorants also have antimicrobial properties. Specific combinations with particular effectiveness toward gram-positive bacteria are used for the composition of so-called deodorant perfumes.

A large number of essential oils or characteristic ingredients thereof, such as, for example, oil of cloves (eugenol), mint oil (menthol) or thyme oil (thymol), also exhibit excellent antimicrobial effectiveness.

The antimicrobially effective substances are generally used in concentrations of from about 0.1 to 0.3% by weight of the preparation.

Examples of suitable pearlescent waxes are, for example: alkylene glycol esters, specifically ethylene glycol disterate; fatty acid alkanolamides, specifically coconut fatty acid diethanoamide; partial glycerides, specifically stearic acid monoglyceride; esters of polybasic, optionally hydroxy-substituted carboxylic acids with fatty alcohols having 6 to 22 carbon atoms, specifically long-chain esters of tartaric acid; fatty substances, such as, for example, fatty alcohols, fatty ketones, fatty aldehydes, fatty ethers and fatty carbonates which have a total of at least 24 carbon atoms, specifically laurone and distearyl ether; fatty acids, such as stearic acid, hydroxystearic acid or behenic acid, ring-opening products of olefin epoxides having 12 to 22 carbon atoms with fatty alcohols having 12 to 22 carbon atoms and/or polyols having 2 to 15 carbon atoms and 2 to 10 hydroxyl groups, and mixtures thereof.

Further Polymers

The cosmetic compositions according to the invention can comprise at least one further, cosmetically or dermatologically acceptable polymer which is different from the polymer according to the invention to establish the desired composition properties. Suitable for this purpose are, quite generally, anionic, cationic, amphoteric and neutral polymers.

Anionic polymers are, for example, homopolymers and copolymers of acrylic acid and methacrylic acid or salts thereof, copolymers of acrylic acid and acrylamide and salts thereof; sodium salts of polyhydroxycarboxylic acids, water-soluble or water-dispersible polyesters, polyurethanes, e.g. Luviset PUR® from BASF, and polyureas. Particularly suitable polymers are copolymers of t-butyl acrylate, ethyl acrylate, methacrylic acid (e.g. Luvimer® 100P), copolymers of ethyl acrylate and methacrylic acid (e.g. Luviflex® Soft and Luvimer® MAE), copolymers of N-tert-butyl acrylamide, ethyl acrylate, acrylic acid (Ultrahold® 8, strong), copolymers of vinyl acetate, crotonic acid and where appropriate, further vinyl esters (e.g. Luviset® grades, INCI: VA/crotonates copolymer), maleic anhydride copolymers, optionally reacted with alcohol, anionic polysiloxanes, e.g. carboxyfunctional, t-butyl acrylate, methacrylic acid (e.g. Luviskol® VBM), copolymers of acrylic acid and methacrylic acid with hydrophobic monomers, such as, for example, C₄-C₃₀-alkyl esters of meth(acrylic acid), C₄-C₃₀-alkylvinyl esters, C₄-C₃₀-alkylvinyl ethers and hyaluronic acid. Examples of anionic polymers are also vinyl acetate/crotonic acid copolymers, as are commercially available, for example, under the names Resyn® (National Starch) and Gafset® (GAF) and vinylpyrrolidone/vinyl acrylate copolymers obtainable, for example, under the trade name Luviflex® (BASF). Further suitable polymers are the vinylpyrrolidone/acrylate terpolymer available under the name Luviflex® VBM-35 (BASF), and polyamides containing sodium sulfonate or polyesters containing sodium sulfonate.

In addition, the group of polymers suitable for the combination with the polymers according to the invention are, for example, Balance® CR (National Starch; acrylate copolymer), Balance® 0/55 (National Starch; acrylate copolymer), Balance® 47 (National Starch; octylacrylamide/acrylate/butylaminoethyl methacrylate copolymer), Aquaflex® FX 64 (ISP; isobutylene/ethylmaleimide/hydroxyethylmaleimide copolymer), Aquaflex® SF-40 (ISP/National Starch; VP/vinylcaprolactam/DMAPA acrylate copolymer), Allianz® LT-120 (ISP/Rohm & Haas; acrylate/C1-2 succinate/hydroxyacrylate copolymer), Aquarez® HS (Eastman; polyester-1), Diaformer® Z400 (Clariant; methacryloylethylbetaine/methacrylate copolymer), Diaformer® Z-711 (Clariant; methacryloylethyl N-oxide/methacrylate copolymer), Diaformer® Z-712 (Clariant; methacryloylethyl N-oxide/methacrylate copolymer), Omnirez® 2000 (ISP; monoethyl ester of poly(methylvinylether/maleic acid in ethanol), Amphomer® HC (National Starch; acrylate/octylacrylamide copolymer), Amphomer® 28-4910 (National Starch; octylacrylamide/acrylate/butylaminoethyl methacrylate copolymer), Advantage® HC 37 (ISP; terpolymer of vinylcaprolactam/vinylpyrrolidone/dimethylaminoethyl methacrylate), Advantage® LC55 and LC80 or LC A and LC E, Advantage® Plus (ISP; VA/butyl maleate/isobornyl acrylate copolymer), Aculyne® 258 (Rohm & Haas; acrylate/hydroxyester acrylate copolymer), Luviset® P.U.R. (BASF, polyurethane-1), Luviflex® Silk (BASF), Eastman® AQ 48 (Eastman), Styleze® CC-10 (ISP; VP/DMAPA acrylates copolymer), Styleze® 2000 (ISP; VP/acrylates/lauryl methacrylate copolymer), DynamX (National Starch; polyurethane-14 AMP acrylates copolymer), Resyn XP (National Starch; acrylates/octylacrylamide copolymer), Fixomer A-30 (Ondeo Nalco; polymethacrylic acid (and) acrylamidomethyl propane sulfonic acid), Fixate G-100 (Noveon; AMP acrylates/allyl methacrylate copolymer).

Further suitable polymers are cationic polymers with the INCI name Polyquaternium, e.g. copolymers of vinylpyrrolidone/N-vinylimidazolium salts (Luviquat® FC, Luviquat® HM, Luviquat® MS, Luviquat® Ultracare), copolymers of N-vinylpyrrolidone/dimethyl-aminoethyl methacrylate, quaternized with diethyl sulfate (Luviquat® PQ 11, INCI: Polyquaternium-11), copolymers of N-vinylcaprolactam/N-vinylpyrrolidone/N-vinyl-imidazolium salts (Luviquat® Hold; INCI: Polyquaternium-46); cationic cellulose derivatives (Polyquaternium-4 and -10), acrylamido copolymers (Polyquaternium-7), chitosan, cationic starch derivatives (INCI: Starch Hydroxypropyltrimonium Chloride, Corn Starch Modified), cationic guar derivatives (INCI: Hydroxypropyl Guar Hydroxypropyltrimonium Chloride), cationic sunflower oil derivatives (INCI: Sunflowerseedamidopropyl hydroxyethyldimonium Chloride), copolymers of acrylic acid, acrylamide and methacrylamidopropyltrimonium chloride (INCI: Polyquaternium-53), Polyquaternium-32, Polyquaternium-28 and others. Suitable cationic (quaternized) polymers are also Merquat® (polymer based on dimethyldiallylammonium chloride), Gafquat® (quaternary polymers which are produced by the reaction of polyvinylpyrrolidone with quaternary ammonium compounds), polymer JR (hydroxyethylcellulose with cationic groups) and plant-based cationic polymers, e.g. guar polymers such as the Jaguar® grades from Rhodia.

Further suitable polymers are also neutral polymers, such as polyvinylpyrrolidones, copolymers of N-vinylpyrrolidone and vinyl acetate and/or vinyl propionate, polysiloxanes, polyvinylcaprolactam and other copolymers containing N-vinylpyrrolidone, copolymers of N-vinylpyrrolidone and alkyl acrylate or methacrylate monomers with alkyl chains of C₁ to C₁₈, graft copolymers of polyvinyl alcohol onto polyalkylene glycols, such as, for example, Kollicoat®IR (BASF), graft copolymers of other vinyl monomers onto polyalkylene glycols, polysiloxanes, polyvinylcaprolactam and copolymers with N-vinylpyrrolidone, polyethyleneimines and salts thereof, polyvinylamines and salts thereof, cellulose derivatives, chitosan, polyaspartic acid salts and derivatives, polyethyleneimines and salts thereof, polyvinylamines and salts thereof, cellulose derivatives, polyaspartic acid salts and derivatives. These include, for example, Luviflex® Swing (partially saponified copolymer of polyvinyl acetate and polyethylene glycol, BASF).

Suitable polymers are also nonionic, water-soluble or water-dispersible polymers or oligomers, such as polyvinylcaprolactam, e.g. Luviskol® Plus (BASF), or polyvinylpyrrolidone and copolymers thereof, in particular with vinyl esters, such as vinyl acetate, e.g. Luviskol® VA 37 (BASF); polyamides, e.g. based on itaconic acid and aliphatic diamines, as are described, for example, in DE-A-43 33 238.

Suitable polymers are also amphoteric or zwitterionic polymers, such as the octylacrylamide/methyl methacrylate/tert-butylaminoethyl methacrylate/2-hydroxypropyl methacrylate copolymers obtainable under the names Amphomer® (National Starch), and zwitterionic polymers as are disclosed, for example, in DE-A 39 29 973, DE-A 21 50 557, DE-A 28 17 369 and DE-A 37 08 451. Acrylamideopropyltrimethylammonium chloride/acrylic acid or methacrylic acid copolymers and alkali metal and ammonium salts thereof are preferred zwitterionic polymers. Further suitable zwitterionic polymers are methacroylethylbetaine/methacrylate copolymers which are available commercially under the name Amersette® (AMERCHOL), and copolymers of hydroxyethyl methacrylate, methyl methacrylate, N,N-dimethylaminoethyl methacrylate and acrylic acid (Jordapon®).

Suitable polymers are also nonionic, siloxane-containing, water-soluble or -dispersible polymers, e.g. polyether siloxanes, such as Tegopren® (Goldschmidt) or Belsil® (Wacker).

Pharmaceutical Compositions

The pharmaceutically acceptable polymers according to the invention can also advantageously be used for the preparation of pharmaceutical compositions. Pharmaceutically acceptable auxiliaries are those which are known for use in the field of pharmacy, food technology and related fields, in particular those specified in the relevant pharmacopoeia (e.g. DAB Ph. Eur. BP NF), and other auxiliaries whose properties do not preclude a physiological application.

Suitable auxiliaries may be: lubricants, wetting agents, emulsifying and suspending agents, preserving agents, antioxidants, antiirritatives, chelating agents, emulsion stabilizers, film formers, gel formers, taste-masking agents, resins, hydrocolloids, solvents, solubility promoters, neutralizing agents, permeation accelerators, pigments, quaternary ammonium compounds, refatting and superfatting agents, ointment, cream or oil base substances, silicone derivatives, stabilizers, sterilizers, propellants, drying agents, opacifiers, thickeners, waxes, emollients, white oils. Formulation in this regard is based on specialist knowledge, as given, for example, in Fiedler, H. P. Lexikon der Hilfsstoffe für Pharmazie, Kosmetik and angrenzende Gebiete [Lexicon of auxiliaries for pharmacy, cosmetics and related fields], 4th ed., Aulendorf: ECV-Editio-Kantor-Verlag, 1996.

To prepare the dermatological compositions according to the invention, the active ingredients can be mixed or diluted with a suitable auxiliary (excipient). Excipients may be solid, semisolid or liquid materials which can serve as vehicles, carriers or medium for the active ingredient. The admixing of further auxiliaries is carried out, where desired, in the manner known to the person skilled in the art. In addition, the polymers are suitable as auxiliaries in pharmacy, preferably as or in (a) coating(s) or binder(s) for solid drug forms. They can also be used in creams and as tablet coatings and tablet binders.

Skin-Cleansing Compositions

In a further preferred embodiment, the polymers according to the invention are used in preparations for skin cleansing.

Preferred skin-cleansing compositions are soaps of liquid to gel-like consistency, such as transparent soaps, luxury soaps, deodorant soaps, cream soaps, baby soaps, skin protection soaps, abrasive soaps and syndets, pasty soaps, soft soaps and washing pastes, liquid washing, showering and bathing preparations, such as washing lotions, shower baths and shower gels, foam baths, oil baths and scrub preparations, shaving foams, lotions and creams.

Hair-Treatment Compositions

According to a particularly preferred embodiment, the compositions according to the invention are hair-treatment compositions.

Hair-treatment compositions according to the invention preferably comprise at least one polymer according to the invention in an amount in the range from about 0.1 to 30% by weight, preferably 0.5 to 20% by weight, based on the total weight of the composition.

The hair-treatment compositions according to the invention are preferably in the form of a setting foam, hair mousse, hair gel, shampoo, hairspray, hair foam, end fluid, neutralizing agent for permanent waves, hair colorant and bleach or hot-oil treatment. Depending on the field of use, the hair cosmetic preparations can be applied in the form of an (aerosol) spray, (aerosol) foam, gel, gel spray, cream, lotion or wax. Hairsprays include both aerosol sprays and also pump sprays without propellant gas. Hair foams include both aerosol foams and also pump foams without propellant gas. Hairsprays and hair foams preferably comprise predominantly or exclusively water-soluble or water-dispersible components. If the compounds used in the hairsprays and hair foams according to the invention are water-dispersible, they can be applied in the form of aqueous microdispersions with particle diameters of usually 1 to 350 nm, preferably 1 to 250 nm. The solids contents of these preparations here are usually in a range from about 0.5 to 20% by weight. These microdispersions generally require no emulsifiers or surfactants for their stabilization.

In a preferred embodiment, the hair cosmetic formulations according to the invention comprise
I. 0.05 to 20% by weight of at least one polymer according to the invention,
II. 20 to 99.95% by weight of water and/or alcohol,
III. 0 to 79.5% by weight of further constituents.

Alcohol is understood as meaning all alcohols customary in cosmetics, e.g. ethanol, isopropanol, n-propanol.

Further constituents are understood as meaning the additives customary in cosmetics, some of which have already been mentioned, for example propellants, antifoams, interface-active compounds, i.e. surfactants, emulsifiers, foam formers and solubilizers. The interface-active compounds used may be anionic, cationic, amphoteric or neutral. Further customary constituents may also be, for example, preservatives, perfume oils, opacifiers, active ingredients, antioxidants, UV filters, care substances, such as panthenol, collagen, vitamins, protein hydrolysates, alpha- and beta-hydroxycarboxylic acids, protein hydrolysates, stabilizers, pH regulators, dyes, viscosity regulators, gel formers, dyes, salts, humectants, refatting agents, complexing agents and further customary additives.

These also include all styling and conditioning polymers known in cosmetics which may be used in combination with the polymers according to the invention if very specific properties are to be set.

Suitable conventional hair cosmetic polymers are, for example, the abovementioned cationic, anionic, neutral, nonionic and amphoteric polymers, which are hereby incorporated by reference.

To set certain properties, the preparations can additionally also comprise conditioning substances based on silicone compounds. Suitable silicone compounds are, for example, polyalkylsiloxanes, polyarylsiloxanes, polyarylalkylsiloxanes, polyether siloxanes, silicone resins or dimethicone copolyols (CTFA) and aminofunctional silicone compounds such as Amodimethicone (CTFA), “GP4 Silicone Fluid®” and “GP 7100®” (Genesee), “Q2 8220®” (Dow Corning), “AFL 40®” (Union Carbide) or the polymers disclosed in EP-B 852 488, page 4, line 1 to page 6 line 16, which are hereby incorporated by reference in their entirety.

Further suitable mixing partners are also silicone graft polymers which have a silicone-containing polymer backbone and non-silicone-containing side chains or a non-silicone-containing polymer backbone and silicone-containing side chains or a silicone-containing polymer backbone and silicone-containing side chains. Examples of such polymers are Luviflex® Silk (BASF) or those in EP-B 852 488, page 3, lines 20-58.

Furthermore, silicone rubbers are also suitable as mixing partners for the polymers according to the invention in cosmetic preparations. Such silicone rubbers are disclosed in EP-B 852488, page 6, line 17 to page 7, line 6, which is hereby incorporated by reference in its entirety.

The polymers according to the invention are particularly suitable as setting agents in hairstyling preparations, in particular hairsprays (aerosol sprays and pump sprays without propellant gas) and hair foams (aerosol foams and pump foams without propellant gas).

In a preferred embodiment, these preparations comprise
a) 0.1 to 10% by weight of at least one polymer according to the invention,
b) 20 to 99.9% by weight of water and/or alcohol,
c) 0 to 70% by weight of at least one propellant,
d) 0 to 20% by weight of further constituents.

Propellants are the propellants customarily used for hairsprays or aerosol foams. Preference is given to mixtures of propane/butane, pentane, dimethyl ether, 1,1-difluoroethane (HFC-152 a), carbon dioxide, nitrogen or compressed air.

A formulation for aerosol hair foams preferred according to the invention comprises
a) 0.1 to 10% by weight of at least one polymer according to the invention,
b) 55 to 99.8% by weight of water and/or alcohol,
c) 5 to 20% by weight of a propellant,
d) 0.1 to 5% by weight of an emulsifier,
e) 0 to 10% by weight of further constituents.
   Emulsifiers

Emulsifiers which may be used are all emulsifiers customarily used in hair foams. Suitable emulsifiers may be nonionic, cationic or anionic or amphoteric.

Examples of nonionic emulsifiers (INCI nomenclature) are Laureths, e.g. Laureth4; Ceteths, e.g. Cetheth-1, polyethylene glycol cetyl ether; Ceteareths, e.g. Cetheareth-25, polyglycol fatty acid glycerides, hydroxylated lecithin, lactyl esters of fatty acids, alkyl polyglycosides.

Examples of cationic emulsifiers are cetyldimethyl-2-hydroxyethylammonium dihydrogenphosphate, cetyltrimonium chloride, cetyltrimmonium bromide, cocotrimonium methyl sulfate, Quaternium-1 to x (INCI).

Anionic emulsifiers can, for example, be chosen from the group of alkyl sulfates, alkyl ether sulfates, alkylsulfonates, alkylarylsulfonates, alkyl succinates, alkyl sulfosuccinates, N-alkoyl sarcosinates, acyl taurates, acyl isethionates, alkyl phosphates, alkyl ether phosphates, alkyl ether carboxylates, alpha-olefinsulfonates, in particular the alkali metal and alkaline earth metal salts, e.g. sodium, potassium, magnesium, calcium, and ammonium and triethanolamine salts. The alkyl ether sulfates, alkyl ether phosphates and alkyl ether carboxylates can have between 1 and 10 ethylene oxide or propylene oxide units, preferably 1 to 3 ethylene oxide units, in the molecule.

Preferred hair-treatment compositions are in the form of a gel. Such a hair-treatment composition comprises, for example:
a) 0.1 to 20% by weight, preferably 1 to 10% by weight, of at least one polymer according to the invention as defined above,
b) 0 to 40% by weight of at least one carrier (solvent), which is chosen from C₂-C₅-alcohols, in particular ethanol,
c) 0.01 to 5% by weight, preferably 0.2 to 3% by weight, of at least one thickener,
d) 0 to 50% by weight of a propellant,
e) 0 to 10% by weight, preferably 0.1 to 3% by weight, of at least one setting polymer different from a), preferably a water-soluble nonionic polymer,
f) 0 to 1 % by weight of at least one refatting agent, preferably chosen from glycerol and glycerol derivatives,
g) 0 to 30% by weight of further active ingredients and/or auxiliaries, e.g. at least one silicone compound,
h) water ad 100% by weight.

A preparation suitable according to the invention for styling gels can, for example, also have the following composition:
a) 0.1 to 10% by weight of at least one polymer according to the invention,
b) 60 to 99.85% by weight of water and/or alcohol,
c) 0.05 to 10% by weight of a gel former,
d) 0 to 20% by weight of further constituents.

Gel formers which can be used are all gel formers customary in cosmetics. These include slightly crosslinked polyacrylic acid, for example carbomer (INCI), cellulose derivatives, e.g. hydroxypropylcellulose, hydroxyethylcellulose, cationically modified celluloses, polysaccharides, e.g. xanthan gum, caprylic/capric triglyceride, sodium acrylate copolymers, polyquaternium-32 (and) paraffinum liquidum (INCI), sodium acrylate copolymers (and) paraffinum liquidum (and) PPG-1 trideceth-6; acrylamidopropyltrimonium chloride/acrylamide copolymers, steareth-10 allyl ether acrylate copolymers, polyquaternium-37 (and) paraffinum liquidum (and) PPG-1 trideceth-6, polyquaternium 37 (and) propylene glycol dicapratedicaprylate (and) PPG-1 trideceth-6, polyquaternium-7, polyquaternium-44.

The polymers according to the invention can be used as conditioning agents in cosmetic preparations.

The polymers according to the invention can preferably be used in shampoo formulations as setting and/or conditioning agents. Preferred shampoo formulations comprise
a) 0.05 to 10% by weight of at least one polymer according to the invention,
b) 25 to 94.95% by weight of water,
c) 5 to 50% by weight of surfactants,
c) 0 to 5% by weight of a further conditioning agent,
d) 0 to 10% by weight of further cosmetic constituents.

All anionic, neutral, amphoteric or cationic surfactants customarily used in shampoos can be used in the shampoo formulations.

Surfactants

Suitable anionic surfactants are, for example, alkyl sulfates, alkyl ether sulfates, alkylsulfonates, alkylarylsulfonates, alkyl succinates, alkyl sulfosuccinates, N-alkoyl sarcosinates, acyl taurates, acyl isethionates, alkyl phosphates, alkyl ether phosphates, alkyl ether carboxylates, alpha-olefinsulfonates, in particular the alkali metal and alkaline earth metal salts, e.g. sodium, potassium, magnesium, calcium, and ammonium and triethanolamine salts. The alkyl ethersulfates, alkyl etherphosphates and alkyl ethercarboxylates can have between 1 and 10 ethylene oxide or propylene oxide units, preferably 1 to 3 ethylene oxide units, in the molecule.

For example, sodium lauryl sulfate, ammonium lauryl sulfate, sodium lauryl ether sulfate, ammonium lauryl ether sulfate, sodium lauroyl sarcosinate, sodium oleyl succinate, ammonium lauryl sulfosuccinate, sodium dodecylbenzenesulfonate, triethanolamine dodecylbenzenesulfonate are suitable.

Suitable amphoteric surfactants are, for example, alkylbetaines, alkylamidopropylbetaines, alkylsulfobetaines, alkyl glycinates, alkyl carboxyglycinates, alkyl amphoacetates or amphopropionates, alkyl amphodiacetates or amphodipropionates.

For example, cocodimethylsulfopropylbetaine, laurylbetaine, cocamidopropylbetaine or sodium cocamphopropionate can be used.

Suitable nonionic surfactants are, for example, the reaction products of aliphatic alcohols or alkylphenols having 6 to 20 carbon atoms in the alkyl chain, which may be linear or branched, with ethylene oxide and/or propylene oxide. The amount of alkylene oxide is about 6 to 60 mol per mole of alcohol. Also suitable are alkylamine oxides, mono- or dialkylalkanolamides, fatty acid esters of polyethylene glycols, alkyl polyglycosides or sorbitan ether esters.

Furthermore, the shampoo formulations can comprise customary cationic surfactants, such as, for example, quaternary ammonium compounds, for example cetyltrimethylammonium chloride or bromide (INCI: cetrimoniumchloride or bromide), hydroxyethylcetyldimonium phosphate (INCI: Quaternium-44), Luviquat®Mono LS (INCI cocotrimonium methosulfate), poly(oxy-1,2-ethanediyl), ((octadecylnitrilio)tri-2,1-ethanediyl)tris(hydroxy)phosphates (1:1) (salt) (INCI Quaternium-52).

In the shampoo formulations, customary conditioning agents can be used in combination with the polymers according to the invention to achieve certain effects. These include, for example, the abovementioned cationic polymers with the INCI name Polyquaternium, in particular copolymers of vinylpyrrolidone/N-vinylimidazolium salts (Luviquat® FC, Luviquat® HM, Luviquat® MS, Luviquat® Ultracare), copolymers of N-vinylpyrrolidone/dimethylaminoethyl methacrylate, quaternized with diethyl sulfate (Luviquat® PQ 11), copolymers of N-vinylcaprolactam/N-vinylpyrrolidone/N-vinylimidazolium salts (Luviquat® Hold); cationic cellulose derivatives (polyquaternium-4 and -10), acrylamide copolymers (polyquaternium-7). It is also possible to use protein hydrolysates, and conditioning substances based on silicone compounds, for example polyalkylsiloxanes, polyarylsiloxanes, polyarylalkylsiloxanes, polyether siloxanes or silicone resins. Further suitable silicone compounds are dimethicone copolyols (CTFA) and aminofunctional silicone compounds, such as amodimethicones (CTFA). In addition, cationic guar derivatives, such as guar hydroxypropyltrimonium chloride (INCI) can be used.

### EXAMPLES

The examples below are intended to explain the invention in more detail without, however, limiting it thereto:

I. Analysis

Determination of the Average Molecular Weight

The weight-average molecular weight M_{w} was determined by gel permeation. chromatography (=GPC) with aqueous eluents.

The GPC was carried out with a combination of instruments from Agilent (series 1100). These include:

| | |
|---|---|
| Degasser | Model G 1322 A |
| Isocratic pump | Model G 1310 A |
| Autosampler | Model G 1313 A |
| Column oven | Model G 1316 A |
| Control module | Model G 1323 B |
| Differential refractometer | Model G 1362 A |

In the case of polymers dissolved in water, the eluent used was a 0.08 mol/l TRIS-buffer (pH=7.0) in distilled water +0.15 mol/l chloride ions from NaCl and HCl. Separation took place in a separating column combination. Use was made of the columns No. 787 and 788 (each 8×30 mm) from PSS with GRAL BIO linear separating material. The throughflow rate was 0.8 ml/min at a column temperature of 23° C.

Calibration is carried out with polyethylene oxide standard from PPS with molecular weights of M=194-1 700 000 [mol/g].

Determination of the K Value

The K values of the aqueous sodium salt solutions of the copolymers were determined in accordance with H. Fikentscher, Cellulose-Chemie, volume 13, 58-64 and 71-74 (1932) in aqueous solution at a pH of 7, a temperature of 25° C. and a polymer concentration of the sodium salt of the copolymer of 1% by weight.

Determination of the Solids Content

A defined amount of sample (about 0.5-1 g) was weighed into an aluminum dish (initial weight). The sample was dried under an IR lamp (160 volts) for 30 minutes. The mass of the sample was then determined again (final weight). The percentage solids content (SC) is calculated as follows:
SC=final weight×100/initial weight [% by wt.]
Preparation of the diallyl monomers and copolymers
Preparation of the monomeric reactive alkoxylates:

### Example M1

### Diallylamine +20 EO (EO=ethylene oxide)

2.471 kg of diallylamine and 0.126 kg of demineralized water were initially introduced into a 20 I steel reactor with jacket cooling, oxide metering and internal thermometer. The reactor was briefly evacuated and then, at 25° C., nitrogen was used to build up a pressure of 15.4 bar. After 50 minutes, the system was decompressed to 3 bar and heated to 80° C. Then, in the course of 80 minutes, 1.120 kg of ethylene oxide was metered in such that the pressure was maintained between 2.8 and 4.3 bar and the temperature did not exceed 95° C. After the ethylene oxide had been metered in, the mixture was stirred for 120 minutes and then cooled to 50° C. 1.217 kg were drawn off from the reactor. 0.1463 kg of a 45% aqueous KOH solution was added to the remaining material. The temperature was increased to 103° C. and water was removed at a pressure of <10 mbar. Nitrogen was then used to build up a pressure of 2 bar and the mixture was heated to 122° C. and, over the course of 21 hours, 14.817 kg of ethylene oxide were gassed in, during which the pressure was maintained between 2 and 5.5 bar and the temperature did not exceed 135° C. The metered addition was interrupted after 240 minutes, stirring was continued at 118° C., the remaining oxide was metered in over the course of 110 minutes and stirring was continued at this temperature for 129 minutes. The mixture was cooled to 80° C. and 10.36 kg were drawn off from the reactor. The product had an OH number of 62.9 mg of KOH/g.

### Example M2

### Diallylamine +40 EO

The product remaining in the reactor after example M1 was heated in the same reactor to 86° C. and rendered inert with nitrogen and a pressure of 2 bar was built up. The mixture was then heated to 115° C. and, over the course of 240 minutes, 6.964 kg of ethylene oxide were gassed in such that the temperature did not exceed 130° C. and the pressure remained between 2 and 5.8 bar. When the metered addition was complete, the mixture was stirred for 120 minutes at 117° C. and 13.24 kg of product were discharged from the reactor. The product had an OH number of 32.03 mg of KOH/g.

### Example M3

### Diallylamine +80 EO

3.574 kg of the product prepared according to example M1 were treated in the reactor used in example 1 with 0.04464 kg of a 45% strength aqueous KOH solution and reacted analogously to example 2 with 10.105 kg of ethylene oxide. This gave 13.51 kg of reactor product with an OH number of 24.13 mg of KOH/g.

Quaternization

### Example Q1

### Diallylamine +20EO Quaternized

548.18 g of diallylamine +20EO (example Ml) were melted at 60° C. Over the course of one hour, 67.10 g of dimethyl sulfate were added dropwise uniformly to this melt. When addition was complete, the mixture was stirred for a further 2.5 hours at 60° C. in order to complete the reaction.

### Example Q2

### Diallylamine +40EO Quaternized

260.00 g of diallylamine +40EO (example M2) were melted at 65° C. Over the course of one hour, 16.74 g of dimethyl sulfate were added dropwise uniformly to this melt. When the addition was complete, the mixture was stirred for a further 2 hours at 65° C. in order to complete the reaction.

Preparation of the Copolymers

### Example P1

853 g of deionized water, 80 g of N-vinylpyrrolidone, 40 g of a 50% strength by weight aqueous solution of diallylamine +20EO quaternized (example Q1) and 1.5 g of triallylamine were initially introduced under a gentle stream of nitrogen into a 2 liter glass reactor with anchor stirrer, thermometer, nitrogen inlet, reflux condenser and dropping funnel, then adjusted to pH 6.8 with 6.2 g of a 20% strength by weight sulfuric acid and heated to 65° C.

As soon as the desired temperature of 65° C. had been reached, 20 g of a solution of 1.5 g of initiator (Wako® V50) in 60.5 g of water were added over the course of a period of 3 hours. The mixture was then heated to 70° C. and stirred for a further 1 hour and then the remaining initiator solution (42 g) was added over the course of 1 hour. Finally, the mixture was then after-polymerized for a period of 2 hours.

The solids content of the solution was about 10%.

### Example P2

856 g of deionized water, 80 g of N-vinylpyrrolidone, 40 g of a 50% strength by weight aqueous solution of diallylamine +20EO quaternized (example Q1) and 0.75 g of triallylamine were initially introduced under a gentle stream of nitrogen, then adjusted to pH 6.8 with 19 g of a 5% strength by weight sulfuric acid and heated to 65° C. As soon as the desired temperature of 65° C. had been reached, 20 g of a solution of 1.5 g of initiator (Wako® V50) in 60.5 g of water were added over the course of a period of 3 hours. The mixture was then heated to 70° C. and stirred for a further 1 hour and then the remaining initiator solution (42 g) was added over the course of 1 hour. Finally, the mixture was then after-polymerized for a period of 2 hours.

The solids content of the solution was about 10%.

### Example P3

846 g of deionized water, 70 g of N-vinylpyrrolidone, 60 g of a 50% strength by weight aqueous solution of diallylamine +20EO quaternized (example Q1) and 0.75 g of triallylamine were initially introduced under a gentle stream of nitrogen, then adjusted to pH 6.8 with 19 g of a 5% strength by weight sulfuric acid and heated to 65° C. As soon as the desired temperature of 65° C. had been reached, 20 g of a solution of 1.5 g of initiator (Wako® V50) in 60.5 g of water were added over the course of a period of 3 hours. The mixture was then heated to 70° C. and stirred for a further 1 hour and then the remaining initiator solution (42 g) was added over the course of 1 hour. Finally, the mixture was then after-polymerized for a period of 2 hours.

The solids content of the solution was about 10%.

### Example P4

836 g of deionized water, 60 g of N-vinylpyrrolidone, 80 g of a 50% strength by weight aqueous solution of diallylamine +40EO quaternized (example Q2) and 0.75 g of triallylamine were initially introduced under a gentle stream of nitrogen, then adjusted to pH 6.8 with 19 g of a 5% strength by weight sulfuric acid and heated to 65° C. As soon as the desired temperature of 65° C. had been reached, 20 g of a solution of 1.5 g of initiator (Wako® V50) in 60.5 g of water were added over the course of a period of 3 hours. The mixture was then heated to 70° C. and stirred for a further 1 hour and then the remaining initiator solution (42 g) was added over the course of 1 hour. Finally, the mixture was then after-polymerized for a period of 2 hours.

The solids content of the solution was about 10%.

The polymers P1 to P4 according to the invention are used to produce the preparations given below in the form of their 10% strength by weight aqueous solutions, on which, accordingly, the quantitative data is based. Unless expressly noted otherwise, the percentages are percentages by weight.

FB1: Hair Gel Containing Polymers According to the Invention and Luviskol K30

| % | Raw material | Supplier | INCI |
|---|---|---|---|
| 0.50 | Carbopol ® 940 | (6) | Carbomer |
| 87.60 | Water demin. | | Aqua dem. |
| 0.70 | Triethanolamine Care | (1) | Triethanolamine |
| 6.00 | Polymer P1 | (1) | |
| 5.00 | Luviskol ® K30 solution | (1) | PVP |
| q.s. | Perfume oil | | |
| q.s. | Cremophor ® RH 40 | (1) | PEG-40 Hydrogenated |
| | | | Castor Oil |
| 0.10 | Phenonip ® | (42) | Phenoxyethanol, |
| | | | Methylparaben, |
| | | | Butylparaben, Ethylparaben |
| | | | and Propylparaben |
| 0.10 | Vitamin E acetate | | Tocopheryl Acetate |

Suppliers
(1) BASF Aktiengesellschaft
(6) B.F. Goodrich Company Chemical Division
(42) Clariant

FB2: Hair Gel Containing Polymers According to the Invention and Luviskol VA64

| % | Raw material | Supplier | INCI |
|---|---|---|---|
| 0.50 | Carbopol ® 980 | (6) | Carbomer |
| 87.60 | Water demin. | | Aqua dem. |
| 0.90 | Neutrol ® TE | (1) | Tetrahydroxypropyl |
| | | | Ethylenediamine |
| 7.00 | Polymer P2 | (1) | |
| 4.00 | Luviskol ® VA64 W | (1) | VP/VA Copolymer |
| q.s. | Perfume oil | | |
| q.s. | Cremophor ® CO 40 | (1) | PEG-40 Hydrogenated |
| | | | Castor Oil |
| 0.10 | Phenonip ® | (42) | Phenoxyethanol, |
| | | | Methylparaben, Butylparaben, |
| | | | Ethylparaben and |
| | | | Propylparaben |
| 0.10 | 1,2-Propylene glycol | (1) | Propylene Glycol |
| | Care | | |

Suppliers
(1) BASF Aktiengesellschaft
(6) B.F. Goodrich Company Chemical Division
(42) Clariant

FB3: Hair Gel Containing Polymers According to the Invention and Luviskol K90

| % | Raw material | Supplier | INCI |
|---|---|---|---|
| 0.50 | Carbopol ® ETD 2001 | (6) | Carbomer |
| 87.60 | Water demin. | | Aqua dem. |
| 0.70 | Triethanolamine Care | (1) | Triethanolamin |
| 6.00 | Polymer P3 | (1) | |
| 5.00 | Luviskol ® K90 | (1) | PVP |
| q.s. | Perfume oil | | |
| q.s. | Cremophor ® CO 40 | (1) | PEG-40 Hydrogenated |
| | | | Castor Oil |
| 0.10 | Nipagin ® M | (34) | Methylparaben |
| 0.10 | Isopropyl myristate | (27) | Isopropyl Myristate |

Suppliers
(1) BASF Aktiengesellschaft
(6) B.F. Goodrich Company Chemical Division
(34) Nipa Laboratories Ltd.
(27) Cognis Deutschland GmbH

FB4: Hair Gel Containing Polymers According to the Invention and Luviquat Hold

| % | Raw material | Supplier | INCI |
|---|---|---|---|
| 10.00 | Polymer P1 | (1) | |
| 2.50 | Luviquat ® Hold. | (1) | Polyquaternium-46 |
| 15.00 | Ethanol 96% | | Alcohol |
| 70.30 | Water demin. | | Aqua dem |
| 5.00 | Luviskol ® K90 | (1) | PVP |
| 0.10 | Perfume oil | | |
| 0.10 | Glycerol | (20) | Glycerin |
| 2.00 | Natrosol ® 250 HR | (4) | Hydroxyethylcellulose |

Suppliers
(1) BASF Aktiengesellschaft
(6) B.F. Goodrich Company Chemical Division
(20) Merck KGaA
(4) Aqualon GmbH

FB5: Hair Gel Containing Polymers According to the Invention and Amaze

| % | Raw material | Supplier | INCI |
|---|---|---|---|
| 6.00 | Polymer P2 | (1) | |
| 2.00 | Amaze ® | (72) | Corn Starch Modified |
| 0.50 | Hydagen ® HCMF | (27) | Chitosan |
| q.s. | Perfume oil | | |
| q.s. | Cremophor ® CO 40 | (1) | PEG-40 Hydrogenated |
| | | | Castor Oil |
| 0.10 | Abil ® 8843 | (44) | PEG-14 Dimethicone |
| 0.10 | Phenonip ® | (42) | Phenoxyethanol, |
| | | | Methylparaben, Butylparaben, |
| | | | Ethylparaben and |
| | | | Propylparaben |
| 91.40 | Water demin. | | Aqua dem. |

Suppliers
(1) BASF Aktiengesellschaft
(6) B.F. Goodrich Company Chemical Division
(27) Cognis Deutschland GmbH
(42) Clariant
(44) Th. Goldschmidt AG
(72) National Starch & Chemical Limited

FB6: Hair Gel Containing Polymers According to the Invention and Styleze CC-10

| % | Raw material | Supplier | INCI |
|---|---|---|---|
| 8.00 | Polymer P3 | (1) | |
| 5.00 | Styleze ® CC-10 | (65) | VP/DMAPA Acrylates |
| | | | Copolymer |
| 0.05 | AMP | (56) | Aminomethyl Propanol |
| 84.85 | Water demin. | | Aqua dem |
| q.s. | Perfume oil | | |
| q.s. | Cremophor ® RH 40 | (1) | PEG-40 Hydrogenated |
| | | | Castor Oil |
| 0.10 | Dow Corning 190 ® | (16) | Dimethicone Copolyol |
| 0.10 | Phenonip ® | (42) | Phenoxyethanol, |
| | | | Methylparaben, Butylparaben, |
| | | | Ethylparaben and |
| | | | Propylparaben |
| 2.00 | Klucel ® | (4) | Hydroxypropylcellulose |

Suppliers
(1) BASF Aktiengesellschaft
(4) Aqualon GmbH
(16) Dow Corning Corporation
(42) Clariant
(56) Angus Chemical Company
(65) ISP Global Technologies Deutschland GmbH

FB7: Hair Gel Containing Polymers According to the Invention and Styleze 2000

| % | Raw material | Supplier | INCI |
|---|---|---|---|
| 6.00 | Polymer P1 | (1) | |
| 1.00 | Styleze ® 2000 | (65) | VP/Acrylates/Lauryl |
| | | | Methacrylate Copolymer |
| 0.26 | AMP | (56) | Aminomethyl Propanol |
| 90.64 | Water demin. | | Aqua dem |
| q.s. | Perfume oil | | |
| q.s. | Cremophor ® RH 40 | (1) | PEG-40 Hydrogenated |
| | | | Castor Oil |
| 0.10 | Karion F Liquid ® | (20) | Sorbitol |
| 0.10 | Phenonip ® | (42) | Phenoxyethanol, |
| | | | Methylparaben, Butylparaben, |
| | | | Ethylparaben and |
| | | | Propylparaben |
| 2.00 | Hydroxypropyl guar | | Hydroxypropylguar |

Suppliers
(1) BASF Aktiengesellschaft
(20) Merck KGaA
(42) Clariant
(56) Angus Chemical Company
(65) ISP Global Technologies Deutschland GmbH

FB8: Hair Gel Containing Polymers According to the Invention and Allianz LT-120

| % | Raw material | Supplier | INCI |
|---|---|---|---|
| 0.50 | Ultrez ® 10 | (6) | Carbomer |
| 90.01 | Water demin. | | Aqua dem. |
| 0.70 | Triethanolamine Care | (1) | Triethanolamine |
| 6.00 | Polymer P2 | (1) | |
| 2.00 | Allianz ® LT-120 | (61) | Acrylates/C1-2 |
| | | | Succinates/Hydroxy- |
| | | | acrylates Copolymer |
| 0.19 | AMP | (56) | Aminomethyl Propanol |
| q.s. | Perfume oil | | |
| q.s. | Cremophor ® CO 40 | (1) | PEG-40 Hydrogenated |
| | | | Castor Oil |
| 0.10 | Pluracare ® E400 | (1) | PEG-8 |
| 0.10 | Phenonip ® | (42) | Phenoxyethanol, |
| | | | Methylparaben, Butylparaben, |
| | | | Ethylparaben and |
| | | | Propylparaben |
| 0.50 | Natrosol ® 250 HR | (4) | Hdroxyethylcellulose |

Suppliers
(1) BASF Aktiengesellschaft
(4) Aqualon GmbH
(6) B.F. Goodrich Company Chemical Division
(42) Clariant
(56) Angus Chemical Company
(61) Rohm & Haas GmbH

FB9: Hair Gel Containing Polymers According to the Invention and Fixomer A30

| % | Raw material | Supplier | INCI |
|---|---|---|---|
| 7.00 | Polymer P4 | (1) | |
| 7.00 | Fixomer ® A30 | | |
| 0.70 | Triethanolamine Care | (1) | Triethanolamine |
| q.s. | Perfume oil | | |
| q.s. | Cremophor ® CO 40 | (1) | PEG-40 Hydrogenated |
| | | | Castor Oil |
| 0.10 | D-Panthenol USP | (1) | Panthenol |
| 0.10 | Phenonip ® | (42) | Phenoxyethanol, |
| | | | Methylparaben, Butylparaben, |
| | | | Ethylparaben and |
| | | | Propylparaben |
| 84.90 | Water demin. | | Aqua dem. |
| 1.00 | Sepigel ® 305 | (175) | |

Suppliers
(1) BASF Aktiengesellschaft
(42) Clariant
(175) Seppic

FB10: Hair Gel Containing Polymers According to the Invention and PVF

| % | Raw material | Supplier | INCI |
|---|---|---|---|
| 0.50 | Carbopol ® 940 | (6) | Carbomer |
| 90.50 | Water demin. | | Aqua dem. |
| 0.70 | Triethanolamine Care | (1) | Triethanolamine |
| 7.00 | Polymer P1 | (1) | |
| 1.00 | PVF | (72) | Polyvinylformamide |
| q.s. | Perfume oil | | |
| q.s. | Cremophor ® RH 40 | (1) | PEG-40 Hydrogenated |
| | | | Castor Oil |
| 0.10 | Phenonip ® | (42) | Phenoxyethanol, Methylparaben, |
| | | | Butylparaben, Ethylparaben and |
| | | | Propylparaben |
| 0.10 | Uvinul ® MC 80 | (1) | Ethylhexyl Methoxy-cinnamate |
| 0.10 | Abil ® 8843 | (44) | PEG-14 Dimethicone |

Suppliers

| | |
|---|---|
| (1) | BASF Aktiengesellschaft |
| (6) | B. F. Goodrich Company Chemical Division |
| (42) | Clariant |
| (44) | Th. Goldschmidt AG |
| (72) | National Starch & Chemical Limited |

FB11: Hair Gel Containing Polymers According to the Invention

| % | Raw material | Supplier | INCI |
|---|---|---|---|
| 0.50 | Carbopol ® 940 | (6) | Carbomer |
| 88.50 | Water demin. | | Aqua dem. |
| 0.70 | Triethanolamine Care | (1) | Triethanolamine |
| | | | Ethylenediamine |
| 10.00 | Polymer P4 | (1) | |
| q.s. | Perfume oil | | |
| q.s. | Cremophor ® CO 40 | (1) | PEG-40 Hydrogenated |
| | | | Castor Oil |
| 0.10 | Phenonip ® | (42) | Phenoxyethanol, Methylparaben, |
| | | | Butylparaben, Ethylparaben and |
| | | | Propylparaben |
| 0.10 | 1,2-Propylene glycol | (1) | Propylene Glycol |
| | Care | | |
| 0.10 | Isopropyl myristate | (27) | Isopropyl Myristate |

Suppliers

| | |
|---|---|
| (1) | BASF Aktiengesellschaft |
| (6) | B. F. Goodrich Company Chemical Division |
| (27) | Cognis Deutschland GmbH |
| (42) | Clariant |

FB12: Hair Gel Containing Polymers According to the Invention

| % | Raw material | Supplier | INCI |
|---|---|---|---|
| 10.00 | Polymer P2 | (1) | |
| 15.00 | Ethanol 96% | | |
| 72.70 | Water demin. | | Aqua dem |
| 0.10 | Perfume oil | | |
| 0.10 | Glycerol | (20) | Glycerin |
| 0.10 | D-Panthenol USP | (1) | Panthenol |
| 2.00 | Natrosol ® 250 HR | (4) | Hydroxyethylcellulose |

Suppliers

| | |
|---|---|
| (1) | BASF Aktiengesellschaft |
| (6) | B. F. Goodrich Company Chemical Division |
| (20) | Merck KGaA |
| (4) | Aqualon GmbH |

FB13: Hair Gel Containing Polymers According to the Invention

| % | Raw material | Supplier | INCI |
|---|---|---|---|
| 0.50 | Carbopol ® ETD 2001 | (6) | Carbomer |
| 88.50 | Water demin. | | Aqua dem. |
| 0.70 | Triethanolamine Care | (1) | Triethanolamine |
| 10.00 | Polymer P1 | (1) | |
| q.s. | Perfume oil | | |
| q.s. | Cremophor ® CO 40 | (1) | PEG-40 Hydrogenated |
| | | | Castor Oil |
| 0.10 | Nipagin ® M | (34) | Methylparaben |
| 0.10 | Uvinul ® MC 80 | (1) | Ethylhexyl Methoxy- |
| | | | cinnamate |
| 0.10 | Abil ® 8843 | (44) | PEG-14 Dimethicone |

Suppliers

| | |
|---|---|
| (1) | BASF Aktiengesellschaft |
| (6) | B. F. Goodrich Company Chemical Division |
| (34) | Nipa Laboratories Ltd. |
| (44) | Th. Goldschmidt AG |

FB13a: Hair Gel Containing Polymers According to the Invention

| % | Raw material | Supplier | INCI |
|---|---|---|---|
| 10.00 | Polymer P3 | (1) | |
| q.s. | Perfume oil | | |
| q.s. | Cremophor ® CO 40 | (1) | PEG-40 Hydrogenated |
| | | | Castor Oil |
| 0.10 | Palatinol ® A | (1) | Diethyl Phthalate |
| 0.10 | Luvitol ® EHO | (1) | Cetearyl ethylhexanoate |
| 0.10 | Cetiol ® HE | (27) | PEG-7 Glyceryl Cocoate |
| 0.10 | Phenonip ® | (42) | Phenoxyethanol, Methylparaben, |
| | | | Butylparaben, Ethylparaben and |
| | | | Propylparaben |
| 87.70 | Water demin. | | Aqua dem. |
| 2.00 | Luvigel ® EM | (1) | Caprylic/Capric Triglyceryde, |
| | | | Acrylates, Copolymer |

Suppliers

| | |
|---|---|
| (1) | BASF Aktiengesellschaft |
| (27) | Cognis Deutschland GmbH |
| (42) | Clariant |

FB14: Setting Solution Containing Polymers According to the Invention

| % | Raw material | Supplier | INCI |
|---|---|---|---|
| 62.60 | Ethanol 96%. | | Alcohol |
| 30.00 | Water demin. | | Aqua dem. |
| 0.10 | Dow Corning 190 Polyether ® | (16) | Dimethicone Copolyol |
| 0.10 | Perfume oil | | |
| 0.10 | Uvinul ® MC 80 | (1) | Ethylhexyl, Methoxy- |
| | | | cinnamate |
| 0.10 | D-Panthenol USP | (1) | Panthenol |
| 7.00 | Polymer P4 | (1) | |

Suppliers

| | |
|---|---|
| (1) | BASF Aktiengesellschaft |
| (16) | Dow Corning Corporation |

FB15: Setting Solution Containing Polymers According to the Invention

| % | Raw material | Supplier | INCI |
|---|---|---|---|
| 0.10 | Dow Corning 190 Polyether ® | (16) | Dimethicone Copolyol |
| 0.05 | Dow Corning 344 fluid ® | (16) | Cyclomethicone |
| q.s. | Perfume oil | | |
| 53.85 | Ethanol 96% | | Alcohol |
| 40.00 | Water demin. | | Aqua dem. |
| 6.00 | Polymer P1 | (1) | |

Suppliers

| | |
|---|---|
| (1) | BASF Aktiengesellschaft |
| (16) | Dow Corning Corporation |

FB16: Setting Solution Containing Polymers According to the Invention

| % | Raw material | Supplier | INCI |
|---|---|---|---|
| 0.10 | D-Panthenol USP | (1) | Panthenol |
| 0.10 | Nutrilan Keratin W | | |
| 0.10 | Elastin ® PG 2000 | | Hydrolyzed Elastin |
| 0.40 | Uvinul ® M 40 | (1) | Benzophenone-3 |
| 10.00 | Water demin. | | Aqua dem. |
| 84.30 | Ethanol 96% | | Alcohol |
| q.s. | Perfume oil | | |
| 5.00 | Polymer P2 | (1) | |

Suppliers

| | |
|---|---|
| (1) | BASF Aktiengesellschaft |

FB17: Setting Solution Containing Polymers According to the Invention and Luviquat Style

| % | Raw material | Supplier | INCI |
|---|---|---|---|
| 4.00 | Polymer P2 | (1) | Polyvinylcaprolactam |
| 3.50 | Luviquat ® Style | (1) | Polyquaternium-16 |
| 72.20 | Ethanol 96% | | Alcohol |
| 20.00 | Water demin. | | Aqua dem. |
| q.s. | Perfume oil | | |

Suppliers

| | |
|---|---|
| (1) | BASF Aktiengesellschaft |

FB18: Setting Solution Containing Polymers According to the Invention

| % | Raw material | Supplier | INCI |
|---|---|---|---|
| 4.00 | Polymer P1 | (1) | |
| 0.20 | Pluracare ® E 400 | (1) | PEG-8 |
| 0.10 | Perfume oil | | |
| 10.00 | Water demin. | | |
| 85.70 | Ethanol 96% | | Alcohol |

Suppliers

| | |
|---|---|
| (1) | BASF Aktiengesellschaft |

FB19: Pump Spray Containing Polymers According to the Invention

| % | Raw material | Supplier | INCI |
|---|---|---|---|
| 26.00 | Polymer P3 | (1) | |
| 73.70 | Ethanol 96% | | Alcohol |
| 0.10 | Perfume oil | | |
| 0.10 | Uvinul ® MC 80 | (1) | Ethylhexyl Methoxycinnamate |
| 0.10 | Dow Corning 190 ® | (16) | PEG/PPG-18/18 Dimethicone |

Suppliers

| | |
|---|---|
| (1) | BASF Aktiengesellschaft |
| (16) | Dow Corning Corporation |

FB20: Pump Spray Containing Polymers According to the Invention

| % | Raw material | Supplier | INCI |
|---|---|---|---|
| 26.00 | Polymer P2 | (1) | |
| 4.00 | Luviskol ® Plus | (1) | Polyvinylcaprolactam |
| 69.60 | Ethanol 96% | | Alcohol |
| 0.10 | Uvinul ® MC 80 | (1) | Ethylhexyl Methoxycinnamate |
| 0.10 | Dow Corning 344 ® | (16) | Cyclomethicone |
| 0.10 | Dow Corning 556 ® | (16) | Phenyl Trimethicone |

Suppliers

| | |
|---|---|
| (1) | BASF Aktiengesellschaft |
| (16) | Dow Corning Corporation |

FB21: Aerosol Spray NON VOC Containing Polymers According to the Invention

| % | Raw material | Supplier | INCI |
|---|---|---|---|
| 13.00 | Polymer P4 | (1) | |
| 0.10 | Perfume oil | | |
| 0.10 | 1,2-Propylene glycol Care | (1) | Propylene Glykol |
| 0.10 | Citroflex 2 ® | (53) | Triethyl Citrate |
| 46.70 | Water demin. | | Aqua dem |
| 40.00 | HFC 152A | | Hydrofluorocarbon 152a |

Suppliers

| | |
|---|---|
| (1) | ASF Aktiengesellschaft |
| (53) | fizer Chemie |

FB22: Aerosol Spray NON VOC Containing Polymers According to the Invention and Luviset CAN

| % | Raw material | Supplier | INCI |
|---|---|---|---|
| 10.00 | Polymer P1 | (1) | |
| 2.00 | Luviset ® CAN | (1) | VA/Crotonates/Vinyl |
| | | | Neodecanoate Copolymer |
| 0.16 | AMP | (56) | Aminomethyl Propanol |
| 0.10 | Perfume oil | | |
| 0.10 | Phytantriol | (1) | Phytantriol |
| 52.64 | Water demin. | | Aqua dem. |
| 35.00 | HFC 152A | | Hydrofluorocarbon 152a |

Suppliers

| | |
|---|---|
| (1) | BASF Aktiengesellschaft |
| (56) | Angus Chemical Company |

FB23: Aerosol Spray VOC 55 Containing Polymers According to the Invention and Luviset P.U.R.

| % | Raw material | Supplier | INCI |
|---|---|---|---|
| 7.00 | Polymer P4 | (1) | |
| 7.00 | Luviset ® P.U.R. | (1) | Polyurethane-1 |
| | | | Neodecanoate Copolymer |
| 14.30 | Ethanol absolute | | Alcohol |
| 36.50 | Water demin. | | Aqua dem. |
| 0.10 | 1,2-Propylene glycol Care | (1) | Propylene Glycol |
| 0.10 | Perfume oil | | |
| 40.00 | DME | — | Dimethyl ether |

Suppliers

| | |
|---|---|
| (1) | BASF Aktiengesellschaft |

FB24: Aerosol Spray VOC 55 Containing Polymers According to the Invention and Luviskol Plus

| % | Raw material | Supplier | INCI |
|---|---|---|---|
| 10.00 | Polymer P2 | (1) | |
| 5.00 | Luviskol ® Plus. | (1) | Polyvinylcaprolactam |
| 17.00 | Ethanol absolute | | Alcohol |
| 32.80 | Water demin. | | Aqua dem. |
| 0.10 | Niacinamide | | Niacinamide |
| 0.10 | Perfume oil | | |
| 35.00 | DME | | Dimethyl ether |

Suppliers

| | |
|---|---|
| (1) | BASF Aktiengesellschaft |

FB25: Aerosol Spray VOC 80 Containing Polymers According to the Invention and Luvimer 100P

| % | Raw material | Supplier | INCI |
|---|---|---|---|
| 10.00 | Polymer P3 | (1) | |
| 1.00 | Luvimer ® 100P | (1) | Acrylates Copolymer |
| 0.24 | AMP | (56) | Aminomethyl Propanol |
| 35.00 | Ethanol absolute | | Alcohol |
| 8.56 | Water demin. | | Aqua dem. |
| 0.10 | Belsil ® CM040 | (156) | Cyclopentasiloxane |
| 0.10 | Perfume oil | | |
| 10.00 | n-Butane | — | Butane |
| 35.00 | DME | — | Dimethyl ether |

Suppliers

| | |
|---|---|
| (1) | BASF Aktiengesellschaft |
| (56) | Angus Chemical Company |
| (156) | Wacker Chemie GmbH |

FB26: Aerosol Spray VOC 80 Containing Polymers According to the Invention and Luviskol VA37

| % | Raw material | Supplier | INCI |
|---|---|---|---|
| 10.00 | Polymer P1 | (1) | |
| 4.00 | Luviskol ® VA37 | (1) | VP/VA Copolymer |
| 38.00 | Ethanol absolute | | Alcohol |
| 7.70 | Water demin. | | Aqua dem. |
| 0.10 | D-Panthenol USP | (1) | Panthenol |
| 0.10 | Dow Corning 556 ® | (16) | Phenyl Trimethicone |
| 0.10 | Perfume oil | | |
| 40.00 | DME | — | Dimethyl ether |

Suppliers

| | |
|---|---|
| (1) | BASF Aktiengesellschaft |
| (16) | Dow Corning Corporation |

FB27: Aerosol Spray Without Added Water Containing Polymers According to the Invention and Luviflex Silk

| % | Raw material | Supplier | INCI |
|---|---|---|---|
| 7.00 | Polymer P1 | (1) | |
| 4.00 | Luviflex ® Silk. | (1) | PEG/PPG-25/25 Dimethicone/ |
| | | | Acrylates Copolymer |
| 0.47 | AMP | (56) | Aminomethyl Propanol |
| 48.23 | Ethanol absolute | | Alcohol |
| 0.10 | Palatinol ® A | (1) | Diethyl Phthalate |
| 0.10 | D-Panthenol USP | (1) | Panthenol |
| 0.10 | Perfume oil | | |
| 10.00 | Propane/butane | — | Propane/Butane |
| 30.00 | DME | — | Dimethyl ether |

Suppliers

| | |
|---|---|
| (1) | BASF Aktiengesellschaft |
| (56) | Angus Chemical Company |

FB28: Aerosol Spray Without Added Water Containing Polymers According to the Invention and Amphomer

| % | Raw material | Supplier | INCI |
|---|---|---|---|
| 10.00 | Polymer P4 | (1) | |
| 1.00 | Amphomer ® 28-4910 | (72) | Acrylates Copolymer |
| 0.17 | AMP | (56) | Aminomethyl Propanol |
| 43.53 | Ethanol absolute | | Alcohol |
| 0.10 | Dow Corning 193 ® | (16) | PEG-12 Dimethicone |
| 0.10 | Dow Corning 556 ® | (16) | Phenyl Trimethicone |
| 0.10 | Perfume oil | | |
| 45.00 | DME | — | Dimethyl ether |

Suppliers

| | |
|---|---|
| (1) | BASF Aktiengesellschaft |
| (16) | Dow Corning Corporation |
| (56) | Angus Chemical Company |
| (72) | National Starch & Chemical Limited |

FB29: PUMP HAIR SETTING FOAM Containing Polymers According to the Invention

| | | |
|---|---|---|
| 3.00 | Polymer P1 | |
| 1.00 | Luviquat ® Mono CP | Hydroxyethyl Cetyl- |
| | | dimonium Phosphate |
| 0.20 | Cremophor ® A 25 | Ceteareth-25 |
| 0.40 | Perfume oil PC 910.781/Cremophor ® | |
| 95.40 | Water demin. | Aqua dem. |
| q.s. | Preservative | |

Preparation:

Prepare a uniform mixture from the components and transfer to a pump foam bottle.

FB30: PUMP SPRAY

| A | q.s. | Cremophor ® CO 40 | PEG-40 Hydrogenated |
|---|---|---|---|
| | | | Castor Oil |
| | q.s. | Perfume oil | |
| | 75.50 | Water demin. | Aqua dem. |
| | 7.30 | Polymer P1 | |
| B | 1.00 | 1,2-Propylene glycol Care | Propylene Glycol |
| | 0.20 | Uvinul ® P 25 | PEG-25 PABA |
| | 1.00 | Luviquat ® HM 552 | Polyquaternium-16 |
| | 15.00 | Ethanol 96% | Alcohol |

Preparation:

Stir phase A. Add the components of phase B one after the other, distribute uniformly and bottle.

FB31: STYLING WATER Containing Polymers According to the Invention

| | | | |
|---|---|---|---|
| A | 0.70 | Cremophor ® CO 40 | PEG-40 Hydrogenated |
| | | | Castor Oil |
| | 0.20 | Perfume oil | |
| | 75.10 | Water demin. | Aqua dem. |
| | 7.30 | Polymer P1 | |
| B | 1.00 | 1,2-Propylene glycol Care | Propylene Glycol |
| | 0.50 | Luviquat ® Ultracare | Polyquaternium-44 |
| | 0.20 | Uvinul ® P 25 | PEG-25 PABA |
| | 15.00 | Ethanol 96% | Alcohol |

Preparation:

Stir phase A. Add the components of phase B one after the other, distribute homogeneously and bottle.

FB32: HAIR FOAM Containing Polymers According to the Invention

| | | | |
|---|---|---|---|
| A | 0.70 | Cremophor CO 40 | PEG-40 Hydrogenated |
| | | | Castor Oil |
| | 0.20 | Perfume oil | |
| | 78.50 | Water demin. | Aqua dem. |
| B | 0.50 | Luviquat ® Mono LS | Cocotrimonium Methosulfate |
| | 6.70 | Polymer P3 | |
| | 2.50 | Luviquat ® Hold | Polyquaternium-46 |
| | 0.20 | Uvinul ® P 25 | PEG-25 PABA |
| | 0.50 | Pluracare ® E 400 | PEG-8 |
| | 0.20 | Cremophor A 25 | Ceteareth-25 |
| | q.s. | Preservative | |
| C | 10.00 | Propane/butane 3.5 bar | Propane/Butane |
| | | (20° C.) | |

Preparation:

Stir phase A. Add the components of phase B one after the other, distribute homogeneously and bottle together with phase C.

FB33: STYLING MOUSSE Containing Polymers According to the Invention

| | | | |
|---|---|---|---|
| A | 2.00 | Luviquat ® Mono LS | Cocotrimonium Methosulfate |
| | q.s. | Perfume oil | |
| B | 62.85 | Water demin. | Aqua dem. |
| | 7.00 | Polymer P1 | |
| | 2.00 | Luviquat ® PQ 11 | Polyquaternium-11 |
| | 0.20 | Cremophor A 25 | Ceteareth-25 |
| | 0.50 | D-Panthenol USP | Panthenol |
| | 0.05 | Uvinul ® MS 40 | Benzophenone-4 |
| | 0.20 | Dow Corning 949 Cationic ® | |
| | 15.00 | Ethanol 96% | Alcohol |
| C | 0.20 | Natrosol ® 250 HR | Hydroxyethylcellulose |
| D | 10.00 | Propane/butane 3.5 bar | Propane/Butane |
| | | (20° C.) | |

Preparation:

Mix phase A. Add the components of phase B one after the other and mix. Add phase C and stir until homogeneously distributed. Adjust the pH to 6-7. Bottle with phase D.

FB34: SETTING FOAM Containing Polymers According to the Invention

| | | | |
|---|---|---|---|
| A | 2.00 | Luviquat ® Mono LS | Cocotrimonium Methosulfate |
| | q.s. | Perfume oil | |
| B | 83.13 | Water demin. | Aqua dem. |
| | 0.47 | AMP | Aminomethyl Propanol |
| | 0.20 | Preservative | |
| | 0.20 | Abil ® B 8843 | Dimethicone Copolyol |
| C | 4.00 | Polymer P1 | |
| D | 10.00 | Propane/butane 3.5 bar | Propane/Butane |
| | | (20° C.) | |

Preparation:

Mix phase A. Weigh in phase B and dissolve until clear. Stir phase B into phase A. Add phase C and stir. Bottle with phase D.

FB35: WETLOOK SETTING FOAM Containing Polymers According to the Invention

| | | | |
|---|---|---|---|
| A | 3.00 | Luviquat ® Mono LS | Cocotrimonium Methosulfate |
| | 0.20 | Perfume oil | |
| B | 78.80 | Water demin. | Aqua dem. |
| C | 5.00 | Glycerol 87% | Glycerin |
| | q.s. | Preservative | |
| | 3.00 | Polymer P2 | |
| D | 10.00 | Propane/butane 3.5 bar | Propane/Butane |
| | | (20° C.) | |

Preparation:

Mix phase A. Stir phase B into phase A. Add phase C. Bottle with phase D.

FB36: FOAM CONDITIONER Containing Polymers According to the Invention

| | | |
|---|---|---|
| 5.00 | Luviquat ® PQ 11 | Polyquaternium-11 |
| 5.00 | Polymer P2 | |
| 0.50 | Luviquat ® Mono CP | Hydroxyethyl Cetyl- |
| | | dimonium Phosphate |
| 10.00 | Ethanol abs. | Alcohol |
| 0.40 | Perfume oil “Carina”/Cremophor ® RH | |
| q.s. | Preservative | |
| 69.10 | Water demin. | Aqua dem. |
| 10.00 | Propane/butane | Propane/Butane |

Preparation:

Weigh everything together, stir until homogeneously distributed. Bottle.

FB37: SHEEN HAIR WAX Containing Polymers According to the Invention

| | | |
|---|---|---|
| 5.00 | Luvitol ® EHO | Cetearyl Octanoate |
| 5.00 | Castor oil | Castor (Ricinus |
| | | Communis) Oil |
| 17.00 | Vaseline | Petrolatum |
| 7.00 | TeCero-Wachs ® 1030 K | Microcrystalline Wax |
| 6.00 | Beeswax 3044 PH | Bees Wax |
| 5.00 | Polymer P1 (anhydrous) | |
| 3.00 | Uvinul ® MBC 95 | 4-Methylbenzylidene |
| | | Camphor |
| 2.00 | Uvinul ® BMBM | Butyl Methoxydibenzoylmethane |
| 0.10 | Phytantriol | Phytantriol |
| 0.50 | Phenoxyethanol | Phenoxyethanol |
| 48.40 | Paraffin oil, high-viscosity | Mineral Oil |
| 11.00 | Dow Corning 556 fluid ® | Phenyl Trimethicone |
| q.s. | Perfume oil | |

Preparation:

Weigh in the components of phase A and melt.

FB38: COLOR BALSAM

| | | | |
|---|---|---|---|
| A | 1.50 | Cremophor ® A 6 | Ceteareth-6, Stearyl Alcohol |
| | 1.50 | Cremophor ® A 25 | Ceteareth-25 |
| | 3.00 | Cetylstearyl alcohol | Cetearyl Alcohol |
| | 6.00 | Luvitol ® EHO | Cetearyl Octanoate |
| | 0.30 | Phytantriol | Phytantriol |
| B | 7.70 | Luviquat ® Ultracare | Polyquaternium-44 |
| | 6.00 | Polymer P4 | |
| | 2.00 | 1,2-Propylene glycol Care | Propylene Glycol |
| | 1.00 | D-Panthenol USP | Panthenol |
| | q.s. | Preservative | |
| | 70.87 | Water demin. | Aqua dem. |
| C | 0.05 | Basic Violet 14 | C.I. 42510, Basic Violet 14 |
| | 0.08 | Basic Red 76 | C.I. 12245, Basic Red 76 |
| | q.s. | Perfume oil | |
| | q.s. | Citric acid | Citric Acid |

Preparation:

Heat phases A and B separately to about 80° C. Stir phase B into phase A with homogenization, briefly after-homogenize. Cool to about 40° C., add phase C and briefly homogenize again. Adjust the pH to 6 to 7.

FB39: HAIR REPAIR TREATMENT Containing Polymers According to the Invention

| | | | |
|---|---|---|---|
| A | 0.20 | Luvitol ® EHO | Cetearyl Octanoate |
| | 3.00 | Polymer P1 | |
| | 0.10 | Phytantriol | Phytantriol |
| | 2.00 | Cremophor ® CO 40 | PEG-40 Hydrogenated |
| | | | Castor Oil |
| B | q.s. | Perfume oil | |
| | 2.00 | Luviquat ® Mono LS | Cocotrimonium Methosulfate |
| C | 79.70 | Water demin. | Aqua dem. |
| D | 2.00 | Luviquat ® Excellence | Polyquaternium-16 |
| | 1.00 | Silicone oil SF 1288 | Dimethicone Copolyol |
| | q.s. | Preservative | |
| | 10.00 | Ethanol 96% | Alcohol |
| | q.s. | Citric acid | Citric Acid |

Preparation:

Mix phases A and B separately. Stir phase C into phase B. Stir the solution of phases B and C into phase A. Add phase D and stir until thickened. Adjust the pH to 4 to 5.

FB40: HAIR GUM Containing Polymers According to the Invention

| | | | |
|---|---|---|---|
| A | 0.50 | Glucamate SSE-20 | PEG-20 Methyl Glucose |
| | | | Sesquistearate |
| | q.s. | Cremophor ® CO 40 | PEG-40 Hydrogenated |
| | | | Castor Oil |
| | q.s. | Perfume oil | |
| | 30.00 | Water demin. | Aqua dem. |
| B | 10.00 | Luviquat ® Hold | Polyquaternium-46 |
| | 2.00 | Luviskol ® K 90 | PVP |
| | 6.00 | Polymer P2 | |
| | 0.30 | Germall ® 115 | Imidazolidinyl Urea |
| | 0.10 | Euxyl ® K 100 | Benzyl Alcohol, Methyl- |
| | | | chloroisothiazolinone, |
| | | | Methylisothiazone |
| | 0.50 | D-Panthenol USP | Panthenol |
| | 5.00 | Pluracare ® E 6000 | PEG 90 |
| | 3.00 | 1,2-Propylene glycol Care | Propylene Glycol |
| | 40.10 | Water demin. | Aqua dem. |
| C | 2.50 | Natrosol ® 250 HR | Hydroxyethylcellulose |

Preparation:

Solubilize phase A. Dissolve phase B and stir into phase A. Stir phase C into the solution of phases A and B.

FB41: SILKY HAIR COCKTAIL Containing Polymers According to the Invention

| | | | |
|---|---|---|---|
| A | 3.00 | Luvigel ® EM | Caprylic/Capric Triglyceride, |
| | | | Acrylates Copolymer |
| | 3.00 | Polymer P1 (anhydrous) | |
| | 0.50 | Wacker Belsil ® | Dimethicone Copolyol |
| | | DMC 6031 | |
| | 2.00 | Wacker Belsil ® | Dimethicone |
| | | DM 1000 | |
| | 3.00 | Wacker Belsil ® | Cyclomethicone, Dimethiconol |
| | | CM 1000 | |
| | 2.00 | Wacker Belsil ® | Amodimethicone, Cetrimonium |
| | | ADM 6057E | Chloride, Trideceth-10 |
| | 2.00 | Wacker Belsil ® | Phenyl Trimethicone |
| | | PDM 200 | |
| | 1.00 | Macadamia nut oil | Macadamia (Ternifolia) |
| | | | Nut Oil |
| | 0.50 | Vitamin E acetate | Tocopheryl Acetate |
| | 1.00 | Cremophor ® CO 40 | PEG-40 Hydrogenated |
| | | | Castor Oil |
| | q.s. | Perfume oil | |
| B | 77.54 | Water demin. | Aqua dem. |
| | 0.46 | AMP | Aminomethyl Propanol |
| | 4.00 | Luviflex ® Silk | PEG/PPG-25/25 Dimethicone/ |
| | | | Acrylates Copolymer |
| | q.s. | Preservative | |

Preparation:

Mix the components of phase A. Dissolve phase B. Stir phase B into phase A with homogenization.

FB42: OIL SHEEN MOISTURIZER Containing Polymers According to the Invention

| | | | |
|---|---|---|---|
| A | 2.00 | Cetyl alcohol | Cetyl Alcohol |
| | 1.00 | Solan ® ELD | PEG-75 Lanolin |
| | 4.00 | Glycerol monostearate | Glyceryl Stearate |
| | 1.00 | Cremophor A 25 | Ceteareth-25 |
| | 4.00 | Luvitol ® EHO | Cetearyl Octanoate |
| B | 10.00 | Glycerol 87% | Glycerin |
| | 5.00 | Polymer P4 | |
| | 2.00 | 1,2-Propylene glycol | Propylene Glycol |
| | | Care | |
| | 1.00 | Luviquat ® Mono LS | Cocotrimonium Methosulfate |
| | 1.50 | Silicone Microemulsion | Trimethylsilylamodimethicone, |
| | | | SM 2115 Octoxynol-40, |
| | | | Isolaureth-6, Glycerin |
| | 1.00 | Cremophor ® PS 20 | Polysorbate 20 |
| | 67.00 | Water demin. | Aqua dem. |
| C | 0.50 | D-Panthenol USP | Panthenol |
| | q.s. | Preservative | |
| | q.s. | Perfume oil | |
| | q.s. | Citric acid | Citric Acid |

Preparation:

Heat phases A and B separately to about 80° C. Stir phase B into phase A and homogenize. Cool to about 40° C., add phase C and homogenize well again.

FB43: SETTING CREAM HIGH GLOSS Containing Polymers According to the Invention

| | | | |
|---|---|---|---|
| A | 5.00 | Cetyl alcohol | Cetyl Alcohol |
| | 10.00 | Tegin ® | Glyceryl Stearate SE |
| | 5.00 | Isopropyl myristate | Isopropyl Myristate |
| | q.s. | Preservative | |
| | 1.00 | Dow Corning 200 fluid ® | Dimethicone |
| B | 5.00 | Glycerol 87% | Glycerin |
| | 5.00 | Polymer P1 | |
| | 0.20 | Edeta BD | Disodium EDTA |
| | 2.00 | Luviskol ® K 30 | PVP |
| | 66.80 | Water demin. | Aqua dem. |
| C | q.s. | Perfume oil | |

Preparation:

Heat phases A and B separately to about 80° C. Stir phase B into phase A and homogenize. Cool to about 40° C., add phase C and briefly homogenize again.

FB44: PERMANENT WAVE

| | | | |
|---|---|---|---|
| A | 70.95 | Water, demin. | Aqua dem. |
| | 3.00 | Polymer P1 | |
| | 0.20 | Tego Betaine L 7 | Cocamidopropyl Betaine |
| | 0.20 | Cremophor ® PS 20 | Polysorbate 20 |
| | 1.25 | Luviquat ® Excellence | Polyquaternium-16 |
| | 0.20 | Edeta BD | Disodium EDTA |
| | 0.20 | Natrosol 250 HR | Hydroxyethylcellulose |
| B | 8.00 | Thioglycolic acid 80% | Thioglycolic Acid |
| C | 11.00 | Ammonia solution 25% | Ammonium Hydroxide |
| D | 5.00 | Ammonium carbonate | Ammonium Carbonate |

Preparation:

Weigh in the components of phase A and mix. Stir phase B into phase A.

FB45: NEUTRALIZER FOR PERMANENT WAVE Containing Polymers According to the Invention

| | | | |
|---|---|---|---|
| A | 1.00 | Cremophor CO 40 | PEG-40 Hydrogenated |
| | | | Castor Oil |
| | 0.20 | Perfume oil | |
| | 2.00 | Polymer P3 | |
| | 91.60 | Water demin. | Aqua dem. |
| B | 0.20 | Tego Betaine L 7 | Cocamidopropyl Betaine |
| | 0.20 | Cremophor ® A 25 | Ceteareth-25 |
| | 2.50 | Luviquat ® Excellence | Polyquaternium-16 |
| | q.s. | Preservative | |
| C | 2.30 | Hydrogen peroxide 30% | Hydrogen Peroxid |
| D | q.s. | Phosphoric acid 85% | Phosphoric Acid |

Preparation:

Solubilize phase A. Add the components of phase B one after the other and mix. Add phase C and stir again. Adjust the pH to 3.0 to 3.5.

1. A polymer comprising, as monomeric building blocks,
a) at least one diallylamine of the general formula I (monomer A) in neutral or quaternized form 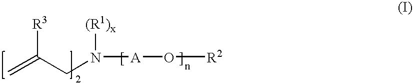
where
A-O is C₁-C₁₂-alkylene oxide, styrene oxide or any mixtures thereof,
n is an integer from 2 to 200,
x is 0 or 1,
R¹ is hydrogen, C₁- to C₂₀-alkyl, C₂- to C₂₀-alkenyl, C₅- to C₁₀-cycloalkyl or an optionally substituted benzyl radical,
R² is hydrogen, C₁- to C₃₀-alkyl, C₅- to C₈-cycloalkyl, C₆- to C₂₀-aryl, C₁- to C₃₀-alkanoyl, C₇- to C₂₁-aroyl, sulfuric(half-)esters, phosphoric esters, amino or ammonium, and
R³ may be identical or different and is hydrogen, C₁- to C₂₀-alkyl, C₂- to C₂₀-alkenyl, C₅- to C₁₀-cycloalkyl or aryl,
b) at least one ethylenically unsaturated monomer (monomer B) chosen from the group consisting of
i. N-vinyllactams,
ii. N-vinylamides,
iii. N-vinylimidazoles,
iv. N,N-diallylamines different from monomer A, and any mixtures of these monomers or salts thereof,
c) if appropriate one or more ethylenically unsaturated monomers C, and
d) if appropriate at least one crosslinker.

2. The polymer according to claim 1, where monomer B is N-vinylcaprolactam or N-vinylpyrrolidone.

3. The polymer according to claim 1, where the weight-average molecular weight M_{w} of the polymer is in the range from 1000 to 2 000 000.

4. The polymer according to claim 1, where the polymer has a K value of from 20 to 120.

5. The polymer according to claim 1, where the monomer mixture to be polymerized comprises
a. 1-95 mol % of monomer A
b. 5-99 mol % of monomer B and
c. 0-50 mol % of monomer C.

6. The polymer according to claim 1, where the polymer comprises 0.01 to 5% by weight of crosslinkers, based on the total amount of the monomers A, B and C.

7. The polymer according to claim 1, where the polymer is soluble or dispersible in water.

8. A process for the preparation of the polymers according to claim 1, wherein the monomers A and B and optionally C and optionally a crosslinker are free-radically polymerized.

9. A cosmetic preparation comprising polymers according to claim 1 and further additives customary in cosmetics.

10. A hair care composition comprising polymers according to claim 1 and further additives customary in hair care.

11. The use of polymers comprising, as monomeric building blocks,
a) at least one diallylamine of the general formula I (monomer A) in neutral or quaternized from 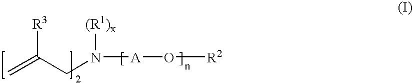
where
A-O is C₁-C₁₂-alkylene oxide, styrene oxide or any mixtures thereof,
n is an integer from 2 to 200,
x is 0 or 1,
R¹ is hydrogen, C₁- to C₂₀-alkyl, C₂- to C₂₀-alkenyl, C₅- to C₁₀-cycloalkyl or an optionally substituted benzyl radical,
R² is hydrogen, C₁- to C₃₀-alkyl, C₅- to C₈-cycloalkyl, C₆- to C₂₀-aryl, C₁- to C₃₀-alkanoyl, C₇- to C₂₁-aroyl, sulfuric(half-)esters, phosphoric esters, amino or ammonium, and
R³ may be identical or different and is hydrogen, C₁- to C₂₀-alkyl, C₂- to C₂₀-alkenyl, C₅- to C₁₀-cycloalkyl or aryl,
b) if appropriate one or more ethylenically unsaturated monomers C, and
c) if appropriate at least one crosslinker
in cosmetic or dermatological preparations.

12. The use according to claim 11, where, as component b), at least one ethylenically unsaturated monomer is selected from the group consisting of
i. N-vinyllactams,
ii. N-vinylamides,
iii. N-vinylimidazoles, and
iv. N,N-diallylamines different from monomer A, and any mixtures of these monomers or salts thereof, is present, in cosmetic preparations or as hair care compositions.

13. A cosmetic composition comprising polymers as defined in claim 12 and further additives customary in cosmetics.

14. The polymer according to claim 2, where the weight-average molecular weight M_{w} of the polymer is in the range from 1000 to 2 000 000.

15. The polymer according to claim 2, where the polymer has a K value of from 20 to 120.

16. The polymer according to claim 2, where the monomer mixture to be polymerized comprises
a. 1-95 mol % of monomer A
b. 5-99 mol % of monomer B and
c. 0-50 mol % of monomer C.

17. The polymer according to claim 2, where the polymer comprises 0.01 to 5% by weight of crosslinkers, based on the total amount of the monomers A, B and C.

18. The polymer according to claim 3, where the polymer has a K value of from 20 to 120.

19. The polymer according to claim 3, where the monomer mixture to be polymerized comprises
a. 1-95 mol % of monomer A
b. 5-99 mol % of monomer B and
c. 0-50 mol % of monomer C.

20. The polymer according to claim 4, where the monomer mixture to be polymerized comprises
a. 1-95 mol % of monomer A
b. 5-99 mol % of monomer B and
c. 0-50 mol % of monomer C.
